(19) United States
(12) Patent Application Publication
(10) Pub. No.: US 2026/0060494 A1
(43) Pub. Date: Mar. 5, 2026

(54) CONE STACK CYCLONE SEPARATOR AND VACUUM CLEANER HAVING SAME

(71) Applicant: Luxnara Yaovaphankul, Samut Prakarn (TH)

(72) Inventor: Luxnara Yaovaphankul, Samut Prakarn (TH)

(21) Appl. No.: 19/108,287

(22) PCT Filed: Aug. 18, 2023
(86) PCT No.: PCT/IB2023/058262

§ 371 Date: Mar. 3, 2025

(30) Foreign Application Priority Data
Sep. 5, 2022 (TH) 2201005586

(51) Int. Cl. A47L 9/16; A47L 9/24; B04C 5/081; B04C 5/103; B04C 5/187; B04C 9/00

(52) U.S. Cl. CPC A47L 9/1608; A47L 9/1666; A47L 9/1683; A47L 9/248; B04C 5/081; B04C 5/103; B04C 5/187; B04C 9/00; B04C 2009/004; B04C 2009/007

(57) ABSTRACT

A vacuum cleaner and fluid separator includes a vortex generating device which generate forced vortex based on the Coanda effect. The generated vortex is the laminar swirling flow causing the fluid particles to be separated into layers. The fluid with bigger particles swirls at the outer layer, while the fluid with smaller particles swirls at the inner layer. The separator further includes stacked cones with a narrow space between the stacked cones to promote separation. The fluid separator further includes the reverse swirl facilitating cone to separate the fluid with bigger particles to be contained in the fluid storage chamber with bigger particles, and draw partial fluid swirling at the inner layer through the connection channel recycle back to the separation system. The vacuum cleaner further includes the preliminary separating section that separate big impurities out before the separation process for the fluid with smaller particles.

### TECHNICAL FIELD

The present invention relates to a cone stack cyclone separator and vacuum cleaner having same.

### BACKGROUND OF RELATED ART

A cyclone separator is a fluid separator commonly used for a long time and provides good result when the heterogeneous fluid required to be separated consist of phases with particles of each phase is significant difference in size or density, for example water and oil. However its efficiency is low when used in separating fluids with each phases's particles is just slightly different in size or density such as fine dust in the air. This is principally caused by the swirling flow generated by the conventional cyclone separator are generated by introducing fluid through the tangential inlet. Thus, the swirling flow generated is free vortex, of which swirling velocity becomes higher while swirling towards the center of the vortex. The particles under such centrifugal force (centrifugal force directly varies with the velocity of the vortex) of which size is smaller or density is lower to be acted with lesser centrifugal force will align to swirl along the outer layer of the vortex, while the bigger or higher density particles to be acted with greater centrifugal force will align to swirl along the inner layer of the vortex. The fluid will be separated again at the vortex reverse point of the cyclone cone. The reverse vortex is the forced vortex type vortex, that is, outer layer vortex velocity is higher than the velocity of the inner layer vortex. Due to the fact that centrifugal force directly varies with the vortex velocity. At the vortex reverse point, fluids centrifuged to the outer layer containing both the big particles centrifuged by the reverse vortex which is the forced vortex and the fluid with smaller particles acted by lesser centrifugal force from former free vortex previously swirling at the outer layer. It thus becomes difficult to separate only fluid containing bigger or higher density particles. To this end, fluid with smaller particles previously swirling at the outer layer is also separated out. If the separating open end at the cone bottom is too small, a portion of the fluid with bigger or higher density particles will not be able to completely be separated out through the cone bottom outlet. It then will reverse to be discharged through the outlet for the fluid with smaller or lower density particles. If the cone bottom outlet is too wide, the fluid flowing down to the storage chamber for fluid with bigger or higher density particles is more than the capacity of the storage chamber for fluid with bigger or higher density particles, will swirl strongly reverse from the storage chamber carrying fluid with bigger or higher density particles in the reverse flow through the outlet for fluid with smaller or lower density particles. Or, in case it is discharged from the separator through the outlet underneath the cone, the proportion of the discarded fluid with respect to the total amount of the fluid will become excessive. That is, the discarded portion partially includes the fluid with smaller or lower density particles.

The use of the conventional cyclone separator in the industrial dust filtering, with the drawbacks of the aforementioned conventional cyclone separator causes fine dust partially incapable of being completely filtered to remain. It is, therefore, necessary to use filter bag or filter layer as the final filtering before releasing the suctioned air to the outside atmosphere.

The use of a cyclone separator in a vacuum cleaner has been common during the recent years due to the fact that the cyclone separator type vacuum cleaner is not prone to be clogged as in the conventional vacuum cleaner using a fabric bag. When the fabric bag is clogged, it will be difficult for the air to flow through. The suction force thus decreases and the efficiency of the vacuum cleaner quickly decrease accordingly. Moreover, cleaning the filter bag covered with dust is harmful to health. With the aforementioned drawbacks in separating out the fine dust of the conventional cyclone separator, in order to meet the acceptable cleanliness standard before releasing it to the atmosphere, a plurality of cyclones are required. The vacuum cleaner, therefore, becomes bulky. The unsolvable problem is that it is impossible for the conventional cyclone separators to filter out the dust carried in the suctioned air to achieve the acceptable cleanliness before being released to the outside atmosphere. The filter layer is required to be used for final-filtering before being released to the outside atmosphere. Such requirement leads to the former problem in the clogging of the filter. Examples of such vacuum cleaner are found in the U.S. Pat. No. 8,979,960 B2. Recently, the popular handheld compact vacuum cleaner gradually abandon cyclone separator to replaced with various kind of filters. Nonetheless, it encounter the same previous problems, that is, the filter is prone to be clogged, then efficiency of the vacuum cleaner is dropped and the filter requires frequent cleaning. Examples of such vacuum cleaner are disclosed in the US Patent Number 2021/0290019 A1.

### SUMMARY OF THE INVENTION

A cyclone separator according to the present invention uses a vortex generating device based on the Coanda Effect principle. The vortex generated is forced vortex with laminar swirling flow i.e. the swirling velocity is highest at the outermost circumference of the vortex. The velocity gradually decreases as the swirling flow approaching the center of the vortex, which is corresponding to the distribution of fluid particles under centrifugal force. That is, fluid with bigger size or higher density particles will be acted upon by greater centrifugal force swirling at the outer layer of the vortex. On the other hand, the fluid particles with smaller or lower density particles acted upon by a lesser centrifugal force will be swirling at the inner layer of the vortex. With the vortex generated based on the Coanda Effect, the vortex will swirl attaching to the convex curve surface beside the aperture to flow as laminar flow, therefore, the fluid particles are separated to distribute in swirling layers in corresponding to particle sizes or density which is easy to be separated. The separation will proceed from the outer layer to the inner layer until the required fluid with a particular particles size or density are obtained.

The cyclone separator according to the present invention further includes stacked cones to increase the surface settling area to promote settling rate or separating rate. The stacked truncated cones with upstream and downstream open end, with each cone mounted separately to form a narrow space between the cones. The stacked cones are mounted after the vortex generating chamber, which large number of cones can be stacked in a limited area. Such arrangement thus provides a large number of spaces between cones and, therefore, large inner shroud areas of the large number of stacked cones. Those areas are the surface settling areas to promote separation and significantly improved separating capability compared to the currently existing cyclone separator having a single cyclone cone or a fewer number of the cones as a consequence of necessity for large areas for the placement.

A cyclone separator according to the present invention further includes a design of the fluid recycle system to recirculate the left over fluid from separation, which fluid with bigger or higher density particles (heavier phase) are partially separated by swirling adjacent to the cones shroud area of the space between cones and swirling adjacent to the wall of the collecting channel for fluid with bigger or higher density particles. To recirculate the left over fluid back to the separating chamber for re-separation for cleaner result, by placing the vacuum motor fan at between the fluid inlet and the vortex generating device, and arrange a connection between the ends of the fluid collecting channel for bigger or higher density particles and the fluid inlet of the separator by arranging a connecting channel at the downstream end of the cone for assisting the reverse swirl flow to connect to the fluid inlet of the separator. With the fluid recycle system to recirculate fluid back to the separation process, create fluid drawing inside the fluid collecting channel for the fluid with bigger particles. The fluid is, therefore, swirly drawn through every space between cones uniformly and thoroughly towards the fluid collecting channel for bigger particles to facilitate an efficient separation on the surface settling areas which are the shroud surfaces of the stacked cones.

In summary, a cone stack cyclone separator according to the present invention comprises a fluid inlet, a vacuum motor fan for drawing in and blowing out, a vortex generating device, a vortex generating chamber, a separating chamber comprising space between cones of the stacked cones, and the separating chamber formed by the downstream open end of the stacked cones. The fluid collecting channel for bigger or higher density particles (heavier phase) located about the upstream open ends of the stacked cones, a cone for promoting reverse swirl flow to separate the fluid with bigger or higher density particles (heavier phase) out of the fluid with smaller or lower density particles (lighter phase) of which brought back to the separating system through the connecting channel which connect with the fluid inlet located before the vacuum motor fan, a storage chamber for bigger or higher density particles (heavier phase), an outlet is provided for the light phase fluid.

Operation of the cone stack cyclone separator according to the present invention begins with the introduction of the fluid from the fluid inlet into the separator by the vacuum motor fan located between fluid inlet and the vortex generating device, to generate partial vacuum to draw the fluid into the separator and blow the fluid to the fluid distributing chamber, to distribute the fluid into the aperture of the vortex generating device which generate swirling flow based on the Coanda Effect principle, which is a conical or cylindrical transmission base with an internal cavity of the configuration. Apertures are installed around the transmission base. Beside the aperture is provided a convex curve surface that curves towards the inner wall of the internal cavity which used as a vortex generating chamber. The convex curve surface beside the aperture is provided as a closest surface compared to other surfaces around the emerging axis of the aperture. The fluid driven through the aperture will be deflected and flows attaching along the convex curve surface beside the aperture and induces the fluid inside the vortex generating chamber to flow into and flow along due to the fact that it is the surface with lower pressure compared to pressure at other portions of the vortex generating chamber filled with fluid. A number of the apertures and the convex curve surfaces beside the apertures are symmetrically mounted around the transmission base of the vortex generating device. Therefore, the fluid flows of each convex curve surface inside the vortex generating chamber flows in relays of each others to cause swirling flow in the vortex generating chamber. Since the fluid pressure is largest at the outlet of the aperture and at the convex curve surface curving towards the inner wall of the vortex generating chamber, the vortex velocity becomes maximal at the vortex layer adjacent to the wall of vortex generating chamber and the vortex velocity gradually decreases when it swirls toward the center of the vortex in corresponding to the reducing thrust. Since the centrifugal force varies directly with the vortex velocity, the centrifugal force becomes maximal at the outermost layer of the vortex. Fluid with bigger or higher density particles (heavier phase) is acted upon by greater centrifugal force swirls at the outer layer of the vortex. Fluid with smaller or lower density particles (lighter phase) is acted upon by lesser centrifugal force swirls at the inner layer of the vortex. When the fluid swirls in the vortex generating chamber for a while, the fluid particles will obviously be dispersed in layers. When fluid swirls to the separating chamber which is the internal cavity formed by the downstream open end of the stacked cones. When fluid swirls to the first space between the first and the second stacked cones (wherein the downstream open end of the first cone is enclosed with the open end of the vortex generating chamber) with the abruptly lengthened circumference of the vortex in corresponding to the circumference of the second stacked cone, fluid with bigger or higher density particles (heavier phase) swirling at the outer layer is thrown to swirl attaching the inner shroud of the stacked cones and then swirls around the shroud of the stacked cones, then swirls down to the fluid collecting channel for bigger or higher density particles (heavier phase). The fluid subsequently swirls attaching the shroud of the fluid collecting channel for bigger or higher density particles (heavier phase) down to the bottom of the fluid collecting channel for bigger or higher density particles. During the swirling attaching to the inner shroud of the cone and the shroud of the fluid collecting channel for bigger particles which is the surface settling area, the fluid with bigger or higher density particles will settle when contacting the surface, the fluid is thus separated, when the fluid with bigger or higher I i density particles swirls to the bottom of the fluid collecting channel for bigger or higher density particles. A cone is mounted to facilitate reverse vortex, provided with an annular spaces between shroud edges of the fluid collecting channel for bigger or higher density particles and the cone for facilitating the reverse vortex. The total cross-sectional areas of the said annular spaces must be smaller than the smallest space that can allow the fluid to completely flow through, enable the left over portion of the light phase fluid swirling at the inner layer of the vortex to swirl reversely up along with cone surface of the reverse swirl facilitating cone. At the vortex reverse point, fluid with bigger particles is separated out to the said spaces, to be collected in the storage chamber for the fluid with bigger or higher density particles. The remaining portion of the fluid with smaller particles which swirling at the inner layer of the vortex will swirl reversely upward into the connecting channel to carry the fluid back to the fluid inlet that precede the vacuum motor fan to be suctioned into the fluid distributing chamber and then into the vortex generating device. This will generate the circulation of the partially sorted fluid back into the separation process again. The fluid is then sorted for several times by the recirculation until the desired clean fluid is obtained. The circulated suction facilitates suction of the fluid from the fluid collecting channel for bigger particles so that induce the fluid in the separating chamber to swirl thoroughly downward to every space between the stacked cones. This enable to achieve high efficiency of fluid separation of the separator according to the present invention.

The remaining portion of the fluid left over after the fluid swirling downward to the first space between cones which previously swirling at the inner layer will swirl outward to become the outer layer vortex, swirls attaching to the inner cone shroud, swirls toward the downstream part of the cone shroud i.e., swirls upward to the end of the second stacked cone. With the space between the second and the third stacked cone, the fluid swirling at the outer layer which is the fluid with bigger particles then centrifuged to swirl attaching to the inner shroud of the third cone and then swirls down the second space between the cones, of which swirling attaching to the inner shroud of each cone to promotes sedimentation, settle down to the fluid collecting channel for bigger or higher density particles. Separation process resumes again at the vortex reverse point promoted by the reverse swirl facilitating cone. Fluid with bigger or higher density particles swirling at the outer layer is separated through the annular space between the shroud of fluid collecting channel for bigger or higher density particles and the reverse swirl facilitating cone, down to the storage chamber for bigger particles. The remaining portion of the fluid swirling at the inner layer will swirl reversely along the reverse swirl facilitating cone up to the connecting channel back to the vortex generating system for the aforementioned separation process.

The remaining portion of the fluid which swirling at the inner layer of the vortex left over from the swirling downward to the second space between cones will swirl outward to become the outer layer of the vortex. It then continuously swirls to the next space between cones. The separation process as mentioned above will occurs again and again in corresponding to the number of spaces between the stacked cones. Due to the fact that such cone stacking allows a great number of cones to be stacked in a limited area, thus a lot of spaces between cones enable separation to happen for a great number of times at the spaces between cones and the great number of shroud areas of the cones which are the surfaces settling area to promote sedimentation. Separation efficiency of the separator according to the present invention is, therefore, highly efficient.

After the fluid was sorted till the last stacked cone, the fluid becomes clean and up to the acceptable standard for discharging out from the fluid separator through the outlet of the fluid with smaller particles (lighter phase) or the outlet of the fluid whose particles were sorted up to the required standard.

With the fluid separator according to the present invention generate forced vortex with laminar swirling flow, the swirling fluid thus separated into layers in corresponding to its particle size or density which is in accordance with the fluid distribution when acted upon by centrifugal force. It is, therefore, easy to be separated (i.e., separate layer by layer from the outer layer towards the inner layer of the vortex). With the fluid separator according to the present invention comprising a lot of stacked cones, which can be stacked in a limited area provided with multiple spaces between cones and big area of cone shroud serving as surface settling area for promoting sedimentation, and the recycle system to recirculate partial fluid back into the the separation system for re-separation, thus, the fluid separator according to the present invention is highly efficient. Due to the fact that the fluid separator according to the present invention can separate the contaminated fluid by using centrifugal force to achieve the required cleanness, no additional filtering device is required for further filtering before the fluid is discharged from the separator. Therefore, maintenance is rarely needed i.e.,no filter is need therefore no need for filter cleaning that impact health. Most important, there is no requirement for the filter that is easily clogged, suction efficiency for the fluid to be suctioned out to allow the semi-vacuum to take place will not subsequently drop as a result of the clogged dirty filter. This is, therefore, suitable for being applied as a variety of filters, for example, industrial vacuum cleaners, household vacuum cleaners, especially, portable vacuum cleaners, or handheld vacuum cleaners.

The vacuum cleaner using the cyclone separator according to the aforementioned invention comprises an inlet for dust and impurities suctioned in along with air, a preliminary separator used for separating large impurities and fibrous rubbish, a storage chamber for large impurities, a fine dust separator using the aforementioned cone stack cyclone separator, a storage chamber for fine dust, an outlet for the filtered clean air.

The preliminary separator of the vacuum cleaner according to the present invention comprises an inlet for dust and rubbish suctioned in along with air, a vortex generating device which generate swirling flow base on Coanda Effect principle with a conical shape or a shallow dome shape that includes a fluid distributing chamber, apertures and a convex curve surface beside the outlet of the aperture which curving towards the outer circumferential surface of the gentle sloped cone or the outer circumferential surface of the shallow dome, a vortex creating chamber/separating chamber used for creating swirling flow and separating the impurities is the chamber surrounding the vortex generating device, a storage chamber used for collecting large and elongated or fibrous impurities which is the lower cavity adjacent to the lower portion of the vortex generating or separating chamber, a connecting passage which connect the downstream portion of the vortex generating chamber or separating chamber with the cone stack cyclone separator according to the present invention, a storage chamber for large impurity which is removable to facilitate the disposal of the impurities.

When impurities and dust are suctioned along with air though the inlet, they are then collected at the fluid distributing chamber of the vortex generating device which is in cylindrical shape of which end is connected with the gentle sloped cone or shallow dome to distribute the fluid to the apertures provided around the cone or dome shroud. Beside the outlet of the aperture is the convex curve surface curving towards the circumferential shroud outside the cone or the shallow dome which is the surface closest to the emerging axis of the aperture. When the fluid including air and impurities is suctioned through the aperture from inside to the external shroud of the cone or the shallow dome, with the influence of the Coanda Effect, the fluid which is air and impurities deflect to flow attaching along the convex curve surface beside the aperture which mounted symmetrically around the cone or around the shallow dome, with the concentric spiral channel of the aperture therethrough generates a forced vortex with laminar swirling flow around the cone or around the shallow dome. Around the vortex generating device is surrounded with the vortex generating chamber, the shroud of vortex generating chamber is in conical shape, the edge of the vortex generating chamber located lower than the base of the vortex generating device. That is, the shroud of vortex generating chamber is extended below the vortex generating device, with the centrifugal force generated by the vortex Impurities with bigger particles are acted upon by higher centrifugal force then thrown out to the outermost layer, thrown to flow attaching the shroud of the vortex generating chamber or separating chamber and swirls down to the storage chamber for large particle impurity where they are stored. While the air contaminated with smaller impurities is acted upon by lesser centrifugal force will swirl at the inner layer, continuously swirl to the dust separator which is the cone stack fluid cyclone separator according to the present invention through the connecting passage which connect with the fluid inlet of the fluid separator according to the present invention. Fine dust is suctioned and blown into the fluid distributing chamber of the vortex generating device which generate swirling flow based on Coanda Effect principle to accelerate vortex velocity in the vortex generating chamber. Subsequently, the dust is centrifuged and dispersed in layers then to be separated in the separating chamber, which are the spaces between cones and the separating chamber formed by the stacked downstream open end of the stacked cones, and at the vortex reversing point swirling reversed by the reverse swirl facilitating cone. As mentioned above, regarding the fluid separator with the stacked cones according to the present invention, dust will be collected at the storage chamber for fine dust, the sorted clean air will be discharged from the vacuum cleaner at the outlet.

The vacuum cleaner according to the present invention separates dust and impurities by the separating sections which comprising the stacked cones which a great number of cones can be stacked in a limited area, and the connecting channel connect between the fluid collecting channel for bigger or higher density particles and the fluid inlets to recycle the fluid back into the separating system. Suctioning of the fluid back to the separating system causes the fluid to swirls down through every spaces between cones. This enable separator to have highly efficient separation even with a compact size, therefore, it is suitable for a portable vacuum cleaner or a handheld vacuum cleaner. Additionally, since the generated vortex is laminar forced vortex, impurities and dust are efficiently separated. Dust can be completely separated out of the air before being discharged from the vacuum cleaner, no filter bag or filter layer is need for re-filtering the air to be cleaned up to the cleanliness standard before being discharged from the vacuum cleaner. Additionally, the vacuum cleaner according to the present invention provided with a preliminary separator for separating the large and elongated or fibrous impurities prior to the fluid separation process in the separator according to the present invention, it thus prevents clogging in the fine dust separating section. The vacuum cleaner according to the present invention is not likely to become clogged, suction efficiency is consistent, suction power is not deteriorated. Since the vacuum cleaner according to the present invention have two storage chambers, one is for the large and fibrous impurity another is for the fine dust, the dust in the storage chamber for dust can be disposable through a trash chute which will not spread out to do any harms to health. Fibrous or large impurities do not contain spreading dust harmful to people's health during disposal either. According to the aforementioned details, the vacuum cleaner according to the present invention provides better or superior advantages over the conventional vacuum cleaners.

The vacuum cleaner according to the present invention is also efficiently applicable to various separation processes at the industrial factories, filtering air intake into the combustion chamber of engine, and dust filtering of the air conditioner.

### BRIEF DESCRIPTION OF THE DRAWINGS

FIG. 1A shows a cone stack cyclone separator and a vacuum cleaner comprising the fluid separator;

FIG. 1B shows details of the swirling system of the cone stack cyclone separator;

FIG. 2 shows the cone stack cyclone separator with the Coanda screen cones and the vacuum cleaner comprising the fluid separator;

FIG. 3A shows the vortex generating device with stationary blades;

FIG. 3B shows details of the vortex generating device with stationary blades and a schematic profile of the device;

FIG. 3C shows details of stationary blades as viewed from inside, at the adjacent hub;

FIG. 4A shows vortex generating device with guide vanes;

FIG. 4B shows details of the vortex generating device with guide vanes and a schematic profile of the device;

FIG. 4C shows details of the guide vanes as viewed from inside, at the adjacent hub;

FIG. 5A shows a schematic profile of the vortex generating device which generate vortex base on Coanda Effect principle;

FIG. 5B shows a vortex generating device which generate vortex base on Coanda Effect principle;

FIG. 6A shows a Coanda screen cone;

FIG. 6B shows a schematic profile of the Coanda screen cone;

FIG. 7A shows a cone vortex generating device;

FIG. 7B shows a section profile of the cone vortex generating device;

FIG. 7C shows top view of the cone vortex generating device;

FIG. 8A shows a shallow circular dome vortex generating device;

FIG. 8B shows a section profile of the shallow circular dome vortex generating device;

FIG. 8C shows top view of the shallow circular dome vortex generating device;

FIG. 9A shows an acceleration gradient profile of the forced vortex;

FIG. 9B shows a distribution profile of the fluid particles when acted upon by the centrifugal force generated by the forced vortex;

FIG. 10A shows a vacuum cleaner comprising fluid separator according to the present invention using a floor vacuum head;

FIG. 10B shows a vacuum cleaner comprising fluid separator according to the present invention using a round brush vacuum head;

FIG. 10C shows a vacuum cleaner comprising fluid separator according to the present invention using a cutting edge vacuum head.

### DETAILED DESCRIPTION OF INVENTION

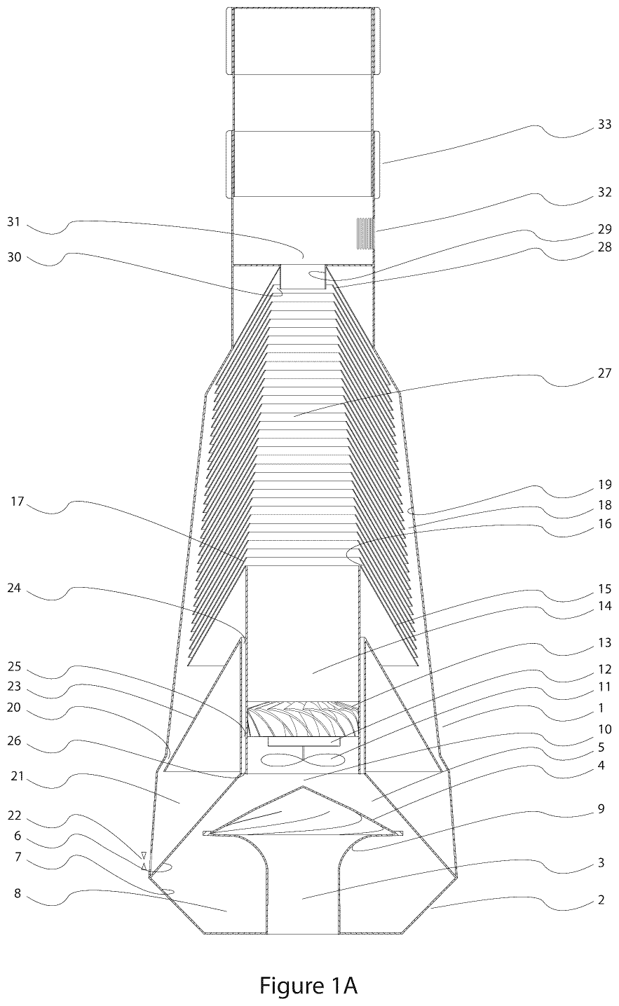

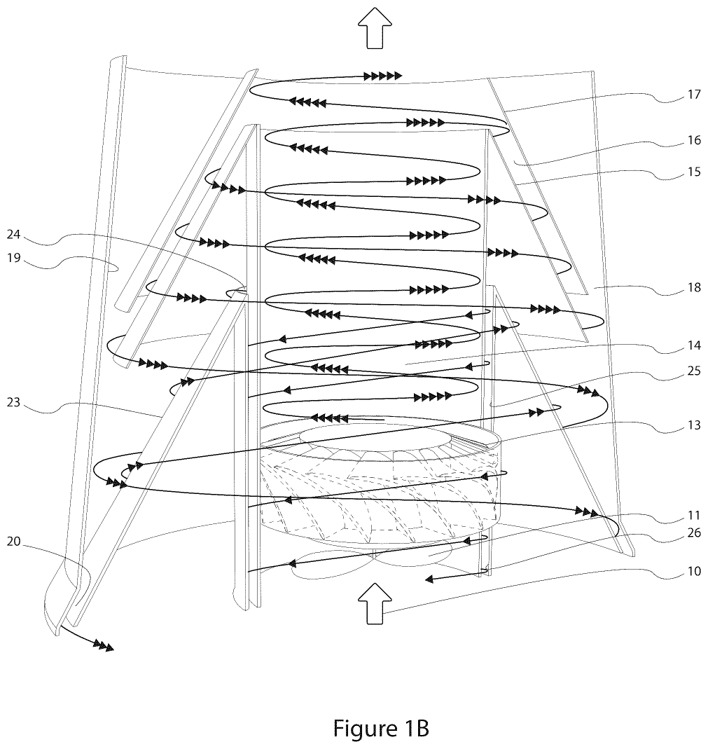

According to FIG. 1A, a cone stack cyclone separator according to the present invention (1) comprising a fluid inlet (10), a vacuum motor fan (11, 12) mounted between the fluid inlet entrance and the vortex generating device to generate partial vacuum to draw fluid into the separator through the fluid inlet, a vortex generating device (13) connected from the vacuum motor fan, a vortex generating chamber (14) mounted after the vortex generating device, a separating section axially mounted after the vortex generating chamber including an internal cavity (27) formed by the stacked downstream open end of the stacked cones at least one space between the stacked cones (16), a fluid collecting channel for bigger or higher density particles (18) located at the upstream open end of the stacked cones at least one cone (15), a reverse swirl facilitating cone (23) mounted at the lower end of the fluid collecting channel for bigger or higher density particles, an annular space used in fluid separation (20) which is an annular space between the shroud (19) of the collecting channel for fluid with bigger or higher density particles and the reverse swirl facilitating cone (23) used in separating the fluid with bigger or higher density particles (heavier phase) out of the fluid with smaller or lower density particles (lighter phase) into the storage chamber for bigger or higher density particles (heavier phase) (21), a connecting channel (25) wherein its inlet entrance (24) is mounted at the the reverse swirl facilitating cone end to recycle the fluid to the separation process, wherein the outlet (26) of connecting channel is connected with the fluid inlet located before the vacuum motor fan, the outlet for the discharge of the fluid with smaller or lower density particles (light phase) (32) out of the fluid separator according to the present invention subsequently located downstream of the stacked cones.

The vacuum motor fan (11, 12) is operated to draw the fluid into the separator and blow the fluid through the vortex generating device (13) to generate vortex to swirl to downstream of the separator according to the present invention. The vacuum motor fan can be implemented with both the motor and the fan are coupled together or the motor is separated from the fan and out of the flow path of the fluid to avoid damages to the motor resulted by the motor being contaminated by the fluid required to be separated or to prevent the motor from being wetted by water in case the separating fluid is liquid by mounting the motor out from the fluid flow path to transfer its rotation power though a shaft fixed with chassis and bearing to the fan mounted between the fluid inlet and the vortex generating device.

Enable the fluid separator according to the present invention to work more efficient, the vortex generating devices which generating the forced vortex with laminar swirling flow are preferable. There are different types of such devices as described hereafter.

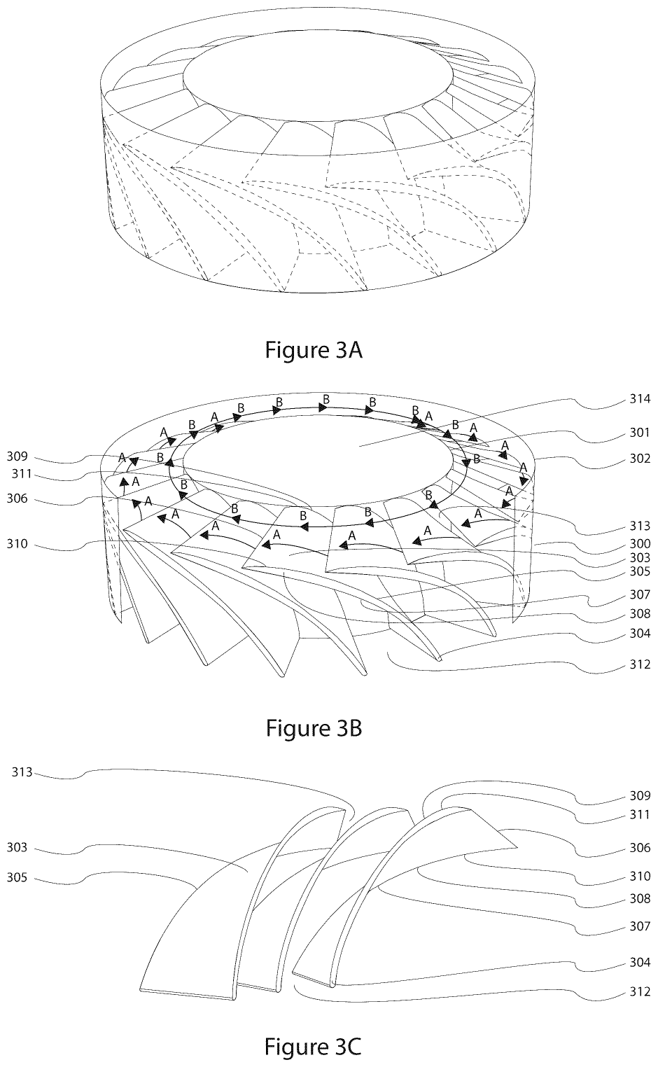

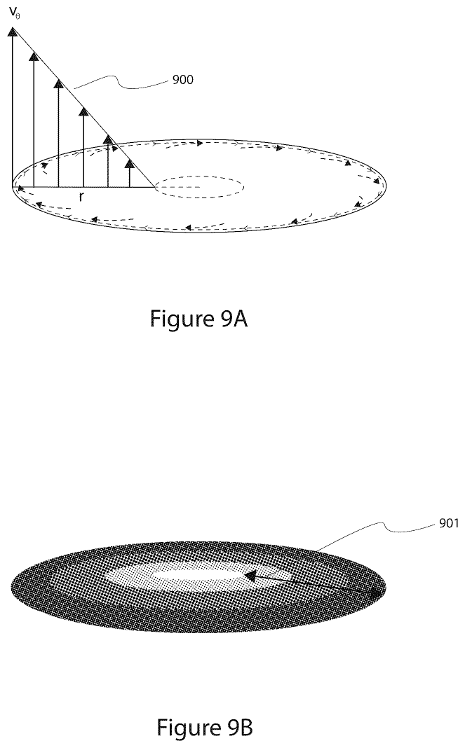

FIGS. 3A, 3B and 3C show the vortex generating device with stationary blades (300) with an aerodynamic surface (303) mounted in the annular space between the hub (301) and the shroud (302) of the cylindrical tube or the conical tube, the hub hole (314) to be covered to let the fluid to pass through only the annular space, enable to obtain the flow velocity including both the magnitude and the direction of the flow as desired i.e., the fluid flow through the stationary blades with high velocity components and high tangential components of the flow, wherein the leading edge (304) of the stationary blade is in convex curvature and the blade spine (305) is curved in convex curvature from the leading edge (304) to the trailing edge (306) enable to generate the Coanda Effect that will deflect the fluid to flow attaching along the convex curve surface of the blade spine, increase thickness of the concave side (307) of the stationary blade to lessen the degree of its concave curvature to reduce flow turbulence and promote to flow attaching along the convex curve surface of the preceding stationary blade, the outer edge (308) of the stationary blade bends in bigger angle and extends longer than the inner edge (309) of the stationary blade. The trailing edge (306) of the stationary blade slightly curves down and the curving-down turning point (310) at the outer edge of the stationary blade curves down to the lower elevation than that of the curving-down turning point (311) at the inner edge of the stationary blade (with respect to the height of the hub). The space between the trailing edges (313) of the stationary blades should be narrower than the space between the leading edges (312) of the stationary blades to increase the velocity of the trailing flow of the stationary blade, the stationary blades with the aforementioned aerodynamic surface are mounted symmetrically around the hub, wherein the wide side of the stationary blade mounted transversely within the annular space between the hub (301) and the shroud (302) and longitudinally, concentrically bends from upstream to downstream of the annular space, at the downstream open end, outer edge of the stationary blade bending down to the lower level and longer distance than the inner edge of the stationary blades. This will create the conical shape surface around the hub. The stationary blades are mounted with respect to the blowing direction of the vacuum motor fan to allow the fluid to be driven by the vacuum motor fan to impact the leading edge at the convex surface of the spine side of the stationary blades. With the Coanda effect, the fluid deflected to flows attaching along the convex curve surface of the blade spine convexly bent from upstream to downstream of the stationary blade along the flow path A. With the placement of the stationary blades around the hub, vortex is generated around the hub along the flow path B with the maximal vortex velocity at the outer edge, the velocity then decreases at the inner layer as a forced vortex as per “the acceleration gradient profile” (900) in FIG. 9A. Since the centrifugal force varies directly with the vortex velocity, the highest centrifugal force is reached at the outermost layer and then decreases at the inner layer. As a result of Coanda effect, the fluid deflect to flow attaching to the surface generating laminar swirling flow. The fluid with bigger or higher density particles is acted upon by the greater centrifugal force swirling at the outer layer separated into layer from the fluid with smaller or lower density particles acted upon by the lesser centrifugal force swirling at the inner layer (901) as shown in the dispersion of the fluid particles when acted upon by the centrifugal force generated by the forced vortex in FIG. 9B.

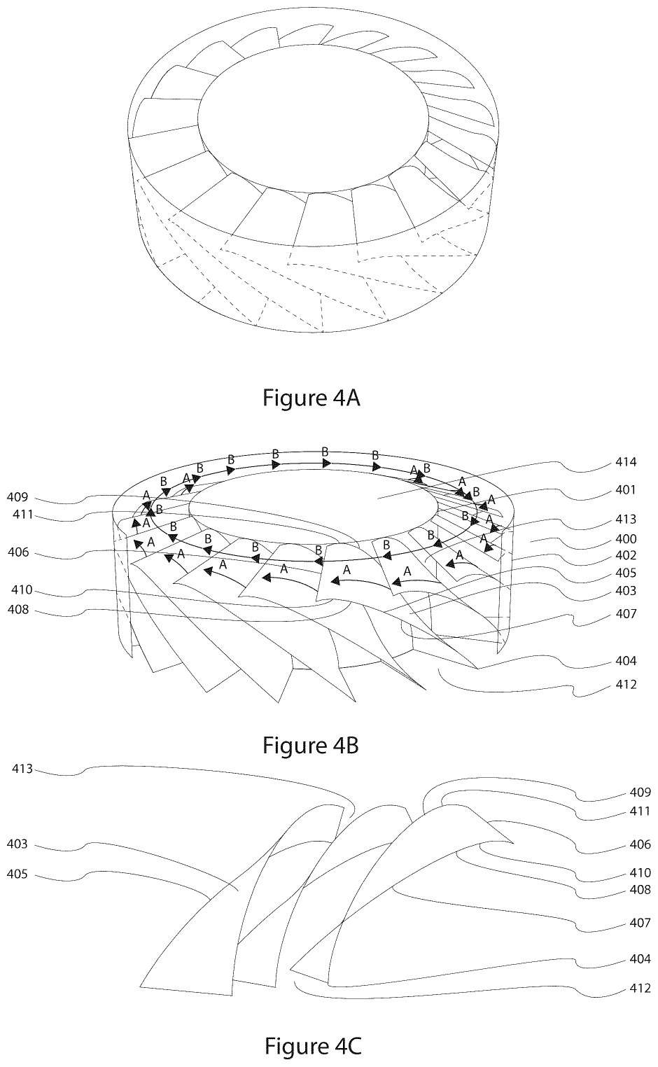

FIGS. 4A, 4B and 4C show the vortex generating device with guide vanes (400) which is a device equipped with guide vanes (403) in the space between the hub (401) and the outer shroud (402) of the cylindrical or conical tube, the hub hole (414) to be closed to let the fluid to flow through the annular space only, guide vanes are mounted from upstream to downstream of the cylindrical or conical tube to generate vortex, with the wide side of the guide vanes mounted transversely in the space between the hub (401) and the outer shroud (402) of the cylindrical or conical tube. The long side of the guide vane are mounted longitudinally, axially from upstream to downstream and transversely, concentrically bent. The spine side (405) of the guide vanes convexly curves from the leading tip (404) to the end (406) of the guide vanes, wherein the ends (406) of the guide vanes makes a transverse concentric spiral twist. The outer edge (408) of the guide vanes is bent down to lower and longer than the inner edge (409) of the guide vane. The end of the guide vanes slightly curves down. The outer edge of the guide vane at the curving-down turning point (410) is lower than (with respect to the hub) the inner edge of the guide vane at the curving-down turning point (411). A plurality of guide vanes are stacked separately with spaces between the guide vanes and symmetrically around the hub of the cylindrical or conical tube, this will provide the guide vanes to bend around the hub. At the end portion of the guide vanes curving down and bending around the hub assembled to form a conical shape around the hub. When the fluid flows through the space between the guide vanes, with Coanda Effect the fluid deflected to flow attaching along the convex curved surface of the guide vanes along the arrow of the flow line A, with the plurality of guide vanes symmetrically mounted around the hub, flow from each guide vane will flow in relay to each other to generate swirling flow around the hub on the surface of the concentric bending guide vanes along the arrow of the flow line B. With Coanda Effect, the fluid flows attaching to the guide vanes to generate laminar swirling flow. With the concentric bending of the guide vanes, the outer edge of the guide vane bending more concentric and longer than the inner edge of the guide vanes, and the outer edge of guide vanes are bent to lower level than the inner edge of guide vane. This will generate a forced vortex wherein the vortex velocity reaches its highest value at the outermost layer of the vortex. The vortex speed decreases while swirling towards the center of the vortex, since the centrifugal force directly varies with the vortex velocity. The centrifugal force is highest at the outermost layer of the vortex and lower at the inner layer of the vortex. The fluid with bigger or higher density particles acted upon by higher centrifugal force swirls at the outer layer, the fluid with smaller or lower density particles acted upon by lower centrifugal force swirls at the inner layer. Since the generated vortex is laminar swirling flow, the fluid particles are distributed in layers according to their sizes or density thus easy to separate, which shown in FIG. 9B.

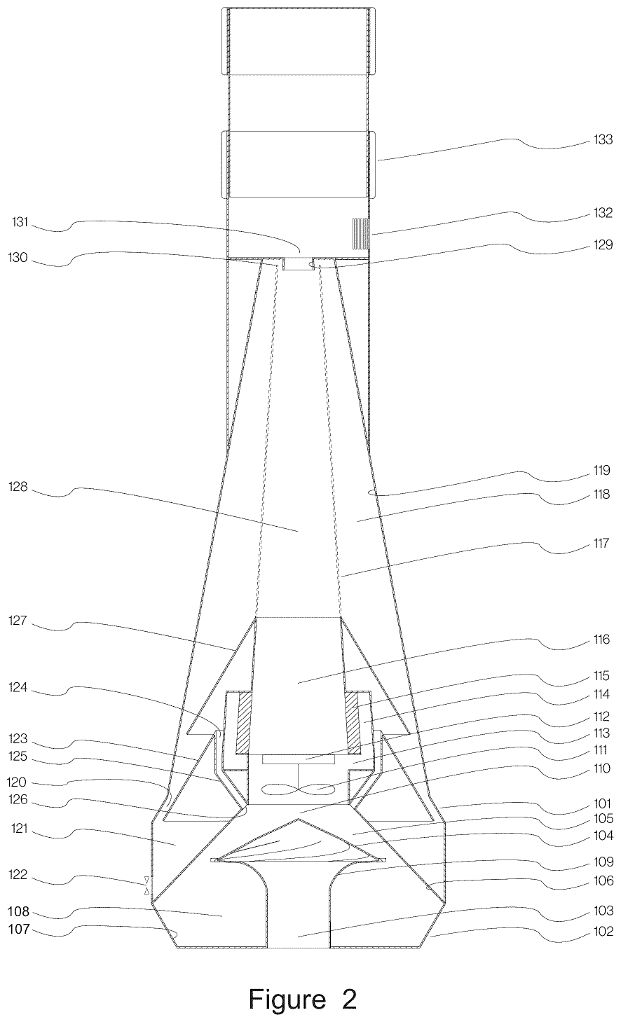

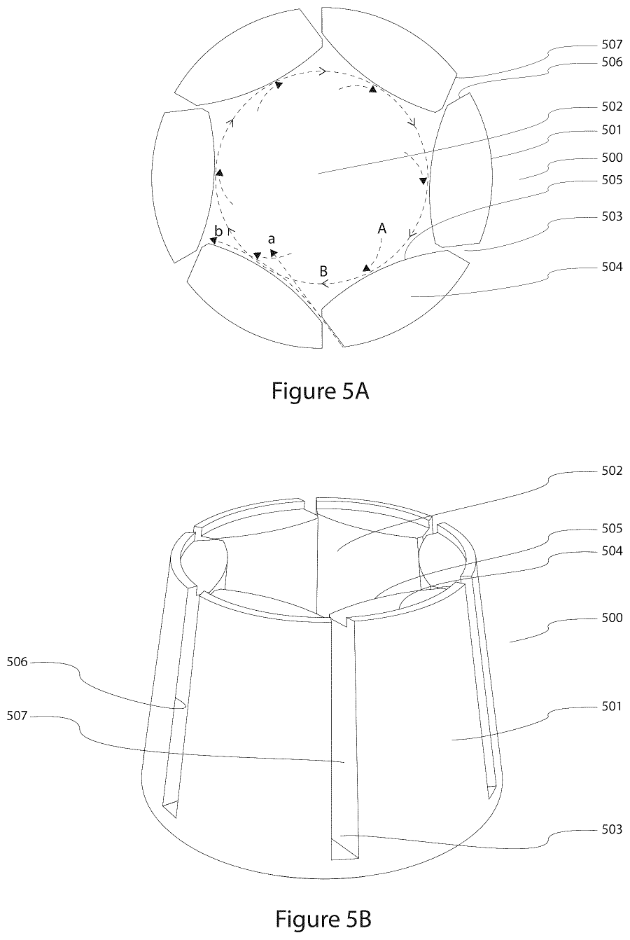

FIG. 5B and FIG. 5A show a vortex generating device (500) which generate vortex based on the Coanda Effect principle, the vortex generated is forced vortex with laminar swirling flow, mounted after the vacuum motor fan. The vortex generating device is a transmission base (501) in conical or cylindrical shape with internal cavity (502) which includes the fluid inlet (113) of the vortex generating device, a fluid distributing chamber (114) of the vortex generating device mounted around the transmission base (115) of the vortex generating device as shown in FIG. 2 to distribute the fluid into the internal cavity of the transmission base through the aperture (503) provided symmetrically around the transmission base wall to introduce the fluid into the internal cavity of the transmission base used as the vortex generating chamber. Beside the aperture at the inside outlet is the convex curve surface (505) beside the aperture curving towards the inner wall of the transmission base. The convex curve surface (505) beside the aperture is mounted as the surface closest to the emerging axis of the aperture (a) compared to other surfaces around the aperture (503). When the fluid is driven through the aperture (503), with Coanda Effect the fluid is deflected to flow attaching along the convex curve surface (505) beside the aperture curving towards the inner wall of the transmission base. Because the pressure is lowest on the surface compare to other place in the internal cavity, as a result of being the wall partitioning the pressure from the side of the convex curve surface while the internal cavity of the transmission base filled with fluid, the flow attaching along the convex curve surface (505) beside the aperture induces the fluid inside the internal cavity of the transmission base to entrain and flow attaching along the convex curve surface (505) beside the aperture curving towards the inner wall of the internal cavity of the transmission base along the arrow of the flow line A. Since aperture (503) and convex curve surface (505) beside the aperture are provided symmetrically around the inner wall of the transmission base, the fluid from each set then flows in relays around the inner wall of the transmission base, create vortex in the internal cavity of the transmission base along the swirling line B. Since driving force is maximal at the outlet of the aperture adjacent to the convex curve surface, the vortex velocity, therefore, is highest at the convex curve surface and gradually decreases when it swirls toward the center of the vortex according to the diminishing driving force, in accordance with the acceleration gradient profile (900) as shown in FIG. 9A. Since the centrifugal force varies directly with the vortex velocity, the centrifugal force is highest at the outermost layer of the vortex. The centrifugal force gradually decreases when it swirls toward the center of the vortex in accordance with vortex velocity, fluid with bigger or higher density particles (heavier phase) acted upon by greater centrifugal force swirls at the outer layer. The fluid with smaller or lower density particles (lighter phase) acted upon by the lesser centrifugal force swirls at the inner layer. As shown by the distribution of the fluid particles acted upon by the centrifugal force generated from the forced vortex (901) as shown in FIG. 9B, the length of the vortex generating chamber extends beyond the aperture for a certain length to provide sufficient area to accelerate the swirling up to the level that the fluid clearly distributed in layers prior reaching the separating section. Due to the vortex is generated by the Coanda Effect, the swirling flow attaching along the convex curve surface beside the aperture as laminar swirling flow. This allows the fluid to be clearly separated into layers according to the particle sizes or density (as a consequence of not being disturbed by turbulent flow). The separation is thus easy to process.

According to FIG. 1A, the fluid separating section of the cyclone separator according to the present invention comprising stacked cones of at least one cone (15) is truncated cone with both upstream and downstream open end mounted axially after the vortex generating chamber (14), the downstream open end of the first stacked cone (15) is enclosed with the downstream open end of the vortex generating chamber (14), each cone is stacked separately with narrow spaces between the cones, provide at least one space (16) between the cones, an internal cavity (27) which is formed by the downstream open end of the stacked cones mounted axially after the vortex generating chamber for use as the separating chamber, enable to increase separation efficiency, the cones can be stacked so that the downstream open end of the subsequent cone slightly set ahead of the downstream open end of the preceding stacked cone to form a internal cavity (27) in the conical shape axially mounted after the vortex generating chamber (14), thus the diameter of the internal cavity gradually shorter longitudinally for use as a separating chamber, at the upstream open end or the base of the stacked cones there is a covering cone to cover the stacked cones, provided an open space between the covering cone and the upstream open end of the stacked cones for use as a collecting channel (18) for the fluid with bigger or higher density particles (heavier phase) sorted from the separating chamber and spaces between the stacked cones at least one space (16) between cones. The cone shroud in the spaces between cones of the stacked cones and the shroud (19) of the collecting channel for the fluid with bigger or higher density particles serves as the surface settling area to promote the separation process. At the bottom end of the fluid collecting channel for bigger or higher density particles a reverse swirl facilitating cone (23) mounted to facilitate reverse swirling, provide with an annular space (20) between the reverse swirl facilitating cone and the shroud of the collecting channel (19) for collecting the fluid with bigger or higher density particles for use as a space for separation. At this vortex reversing point, the fluid with bigger or higher density particles that swirls attaching to the shroud of the collecting channel for fluid with bigger or higher density particles is separated and swirls through the annular space (20) which is a space for separation into the storage chamber for fluid with bigger or higher density particles (21). At the wall of the fluid storage chamber for bigger or higher density particles, a valve is mounted for the opening-closing (22) to discharge the fluid with bigger or higher density particles from the storage chamber, a portion of the fluid with smaller or lower density particles swirling at the inner layer of the vortex swirls reversely up along the reverse swirl facilitating cone into the entrance (24) of the connecting channel (25) which is the space between the reverse swirl facilitating cone and the vortex generating device with outlet (26) connected with the fluid inlet (10) located before the vacuum motor fan for the suction of the fluid through the connecting channel (25) to recycle the fluid back to the separation system.

The storage chamber for bigger or higher density particles may be mounted with a spiral ramp to guide the sorted fluid with bigger or higher density particles to flow through the entrance of storage chamber mounted with check valve downward to the storage chamber for bigger or higher density particles. The flow direction of the check valve allows the unidirectional flow into the storage chamber, no way for returning flow from the storage chamber. This is to prevent the fluid particles contained in the storage chamber from being drawn out during switch on the fluid separator. At the bottom of the storage chamber, can be placed with an opening-closing valve (22) to take the fluid particles contained inside out of the storage chamber.

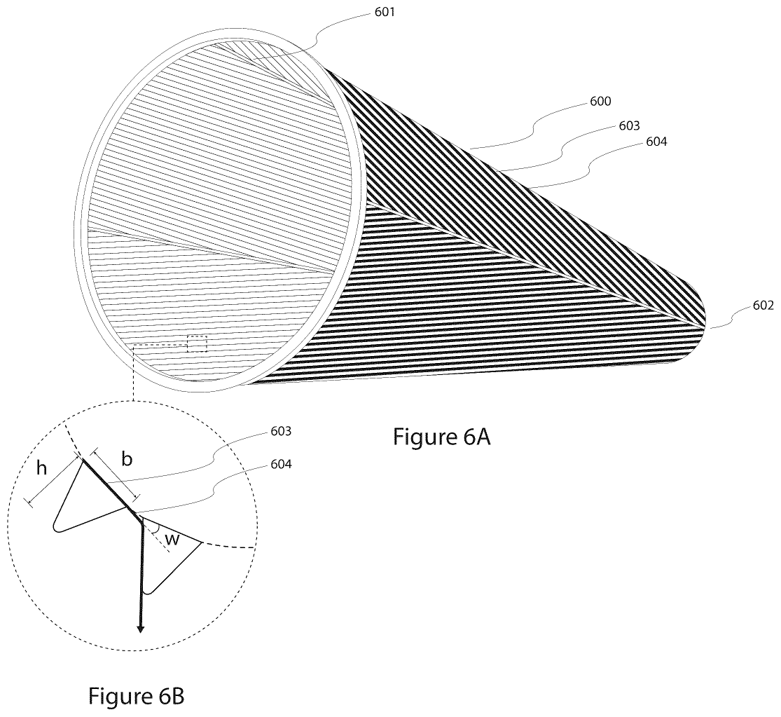

FIG. 2 shows the separating section of the fluid separator according to the present invention with the Coanda screen cone (117) with both upstream and downstream open end with the hollow interior as the internal cavity (128) mounted axially to connect from the vortex generating chamber (116), further down the downstream open end (131) of the Coanda screen cone there is an outlet (132) to bring the sorted fluid out of the fluid separator. According to FIG. 6A, the Coanda screen cone (600) is the cone with upstream open end (601) and downstream open end (602). The internal cavity of the Coanda screen cone serves as a separating chamber. The Coanda screen cone consist of a cone-shape structure with a shroud covered with the wedge wire (603) According to FIG. 6B wedge wire is the wire with a triangle cross section. The wedge wire is longitudinally attached to the cone-shape structure with narrow spaces between the wedge wires (604). The wedge wires wrap around the cone except the equal spaces between the wedge wires wherein the flat side of the wedge wire (b) faces inward to be the inner cone shroud. The wedge wire at the sharp end of the triangle (h) faces outward to be the outer shroud of the cone. With curvature of the circumference of the cone, the flat side of the subsequent wedge wire (from the flow direction of the fluid that swirls inside the cone) have w degrees uprisen angle from the flat side of the preceding wedge wire. This makes the flow path inside the cone from the flat side of the preceding wedge wire flow direct to the triangle side of the subsequent wedge wire (h), as shown by the solid line of the flow. The fluid with bigger or higher density particles (heavy phase) that swirls at the outer layer as a result of being acted upon by greater centrifugal force generated by the vortex generating device and has accelerated the swirling in the vortex generating chamber till the fluid particles are separated into layers according to size or density, wherein the fluid with bigger particles swirls at the outer layer while the smaller or lower density particles swirl at the inner layer. The fluid with bigger or higher density particles that swirls at the outer layer will swirl attaching to the inner shroud of the cone which is the flat side of the wedge wire. With curvature of the of circumference cone, the subsequent wedge wire has an uprisen angle from the preceding wedge wire. With Coanda effect, the fluid flow attaching along the surface thus flows attaching to the flat side of the wedge wire spout directly through the space between the wedge wires (604) flow attaching to the triangle side of the wedge wire (h). With Coanda effect, the fluid flows attaching along the shroud at the triangle side of the wedge wire out of the Coanda screen cone (600), while the fluid with smaller or lower density particles previously swirl at the inner layer of the vortex will flow outward to replace the fluid with bigger particles which flowed out of the Coanda screen, then flow attaching along the inner cone shroud which is the flat side of the next wedge wire (b), then flow across the space between the wedge wires (604) flow attaching to the triangle side of the wedge wire (h) out of Coanda screen cone (600). Such separation process occurs all the time that the fluid continues to swirl in the Coanda screen cone until it swirls to the cone end (602). The fluid that swirls in the cone and completely sorted will be discharged at the outlet for the fluid with smaller or lower density particles. According to FIG. 2, the Coanda screen cone (117) will be covered by the solid cone (119) provided space between the solid covering cone and the Coanda screen cone to act as a collecting channel for the fluid with bigger or higher density particles (118). The fluid separated from the Coanda screen cone still has inertia force that makes the fluid swirl attaching to the shroud of covering cone which is the shroud (119) of the collecting channel for fluid with bigger or higher density particles. At the bottom part of the collecting channel for bigger or higher density particles, a cone for facilitating reverse swirling (123) is mounted to form an annular space (120) between the shroud (119) of the covering cone and the reverse swirl facilitating cone (123) for use as a space for separation. At this vortex reverse point, the fluid with bigger or higher density particle that swirls attaching to the inner shroud of the covering cone which is the shroud (119) of the collecting channel will flow down through the annular space (120) which is the space used for separation, down to the storage chamber for the fluid with bigger or higher density particles (121). At the shroud beside the storage chamber for fluid with bigger particles may mount an opening-closing valve (122) to discharge the fluid with bigger particles out of the storage chamber for fluid with bigger particles. A portion of the fluid with smaller or lower density particles swirling at the inner layer swirls reversely along the reverse swirl facilitating cone (123) into the entrance (124) of the connecting channel (125) which is the space to bring the fluid back into the separation system again at the outlet (126) which is connected with the fluid inlet (110) located before the vacuum motor fan (111, 112). To prevent the fluid that swirls in the collecting channel for the fluid with bigger or higher density particles to flow short cut into the connecting channel (125) being the fluid bought back into the separation process before the fluid swirls downward to the annular separating space (120). This can be prevented by mounting the short cut flow preventing cone (127) to cover the reverse swirl facilitating cone leaving a space between the base of the short cut flow prevention cone (127) and the shroud of the collecting channel for fluid with bigger or higher density particles (119) so that the fluid with bigger particles will swirl downward to the vortex reversing point. The fluid with bigger or higher density particles will be separated through the annular separating space (120) downward to the storage chamber for fluid with bigger or higher density particles. The fluid with smaller or higher density particles will reversely swirl along the reverse swirl facilitating cone to recycle to the separation process by suction through the connecting channel (125).

FIG. 1A and FIG. 2 shows the sorted fluid through the separating section of which is either the stacked cones at least one cone (15) or the Coanda screen cone (117), which will be taken out of the fluid separator at the outlet for the fluid with smaller or lower density particles (light phase), before discharging the fluid out of the last stacked cones (28) or out of the Coanda screen cone, enable to separate the fluid with bigger or higher density particles out of the fluid with smaller or lower density particles in a more complete manner, at the downstream open end of the last stacked cone or Coanda screen cone (28, 117) will be mounted with the cylindrical tube (29, 129) which is smaller than the downstream open end of the last stacked cones or Coanda screen cone (28, 117), wherein the end of the cylindrical tube is longer than the cone end to provide a space (30, 130) to be the collecting channel for fluid with bigger or higher density particles which connected with the main collecting channel for fluid with bigger or higher density particles (18, 118) wherein there is a cone covering the last stacked cones, at the shroud of covering cone is connected with the end shroud of the cylindrical tube and the shroud (19) of the fluid collecting channel, or a ceiling connected the end shroud of the cylindrical tube and the shroud (119) of the fluid collecting channel. The annular space between downstream open end of the cone and the cylindrical tube is the space to separate the fluid with bigger or higher density particles that swirls at the outer layer to return to the fluid collecting channel for fluid with bigger or higher density particles (18, 118).

FIG. 1B shows the operation of the fluid separator according to the present invention, beginning from the vacuum motor fan (11, 12) suctioning fluid through the fluid inlet (10) and blowing to the vortex generating device (13). The vortex generated from the vortex generating device as shown by the swirling line with five arrowheads will swirl in the vortex generating chamber (14) for a certain time interval up to the length of the vortex generating chamber. If, in case, the vortex generating chamber is in the conical shape, the swirling velocity will accelerate longitudinally along the continually shorten circumference of the conical vortex generating chamber. The vortex that swirls for a certain time interval and continuously, longitudinally accelerate the vortex velocity along the continually shorten circumference. The centrifugal force thus increases with respect to the increasing velocity. The fluid is continuously acted upon by the centrifugal force. Therefore, the fluid is clearly separated into layers according to the sizes or density of the fluid particles. The fluid with bigger or higher density particles (heavy phase) acted upon by greater centrifugal force swirls at the outer layer of the vortex. A portion of the fluid with smaller or lower density particles (lighter phase) is acted upon by the lesser centrifugal force will swirl at the inner layer of the vortex. When the swirling fluid are separated into layers according to sizes or density of particles in the vortex generating chamber, swirling to the fluid separating section, in case the separating section of the cyclone fluid separator according to the present invention which is the stacked cones with spaces between the cones for increasing the surface settling area to promote the separation, When fluid swirls to the first space between cones (16), the outer layer of the vortex which is the fluid with bigger or higher density particles (heavy phase) will be thrown by the centrifugal force to swirl attaching to the inner shroud of the second stacked cone (17). The fluid with smaller particles previously swirls at the inner layer will swirl outward to replace as outer layer to swirl attaching to the upper part inner cone shroud as shown by the swirling line with five arrowheads. The fluid with bigger particles is, therefore, driven by the aforesaid process, and suction from fluid inlet through the connecting channel which connect to the collecting channel for fluid with bigger particles located at the upstream open end or the base of the stacked cone to swirl downward to the space between cones (16) as shown by the swirling line with four arrowheads. With the centrifugal force from the vortex, the fluid thus swirls attaching to the inner cone shroud, by swirling attaching to the inner cone shroud and covering cone shroud which is the shroud (19) of the fluid collecting channel for fluid with bigger or higher density particles as shown by the swirling line with three arrowheads, which are the surface settling area for accelerating separation. When fluid swirls to the end of the fluid collecting channel. The fluid with bigger or higher density particles swirls downward through the annular space (20) which is the space for separation located between the shroud (19) of collecting channel and the reverse swirl facilitating cone (23), down to the storage chamber for fluid with bigger or higher density particles (heavier phase) (21). While the fluid with smaller or lower density particles swirling at the inner layer, reversely swirls upward along the reverse swirl facilitating cone (23) as shown by the swirling line with two arrowheads. When it swirls to the tip of the cone, the fluid will swirl downward to the inlet entrance (24) of the connecting channel (25) which is the space between the reverse swirl facilitating cone (23) and the shroud of vortex generating device as shown by the swirling line with one arrowhead, and brought back to separate again in the separating system via the outlet (26) of the connecting channel to connect to the fluid inlet (10) located before vacuum motor fan (11, 12) where the suction force of the vacuum motor fan will draw the fluid through the connection channel. The suction force will lower the pressure in the collecting channel for fluid with bigger or higher density particles (18). It thus draw the fluid through the space between the stacked cones at least one space (16) between the stacked cones, downward to the collecting channel for fluid with bigger or higher density particles (18) and the collecting channel for fluid with bigger particles or higher density particles (18) is narrow at the upstream part and gradually becomes wider when approaching to downstream part (base on the flow direction) enable to thoroughly distribute the suction force. The fluid thus flows throughly through every space between the stacked cones at least one space (16) between the stacked cones without any short cut flow. While the fluid previously flows at the inner layer that swirls from the vortex generating chamber will swirl outward instead and will be thrown to swirl attaching to inner shroud of the upper portion of the stacked cones (17) as shown by the swirling line with five arrowheads, continues to swirl beyond the downstream open end of the cone, it will then be thrown to swirl attaching to the inner shroud of the next stacked cone. The separating process mentioned above occur repeatedly in accordance with the number of the spaces between the stacked cones which is able to stack a great number of cones in a limited area after the vortex generating chamber along the longitudinal axis. The separating process will repeatedly occur until the last stacked cones. There are many spaces between the stacked cones, therefore a great number of the inner shroud areas of the stacked cones, which are the surface settling areas for sedimentation, and thus create the separation at each cone open end, at the inner cone shroud surface at the space between the cones, at the covering cone shroud surface which is the shroud of collecting channel for fluid with bigger or higher density particles and at the annular space between the shroud of collecting channel for fluid with bigger or higher density particles and reverse swirl facilitating cone which is the space for the separation. Therefore, the separator according to the present invention perform fluid separation continuously, therefore, the separation is highly efficient. This enables the fluid to be sorted up to the required standard without the need for additional filter as the final separation before discharging the fluid out of the separator.

According to FIG. 1A and FIG. 2, in order to distribute the suction force to draw the fluid thoroughly through each space between the stacked cones at least one space (16) between cones in case the separating section is the stacked cones, or distribute the suction force to draw the fluid thoroughly through every spaces between the wedge wire in case the separating section is the Coanda screen cone. The collecting channel for fluid with bigger or higher density particles (18, 118) located at the upstream open end of the stacked cones, or located outside the Coanda screen cone, the width of the upstream portion of the collecting channel is narrower than the downstream portion (upstream/downstream is described base on flow direction), wherein the width gradually increase longitudinally.

The separator according to the present invention is compact and highly efficient due to the generated forced vortex generating the centrifugal force to clearly separate fluid particles into swirling layers according to the sizes or density of the particles. The fluid with bigger or higher density particles swirls at the outer layer, the fluid with smaller or lower density particles swirls at the inner layer, therefore, easy for separation. Due to a large cone shroud surfaces which are the surface settling areas promoting separation resulting from the stacking of a great number of cones in a limited area. Due to the multi-separating stages in the separating section, i.e., at the separating chamber which is the axial cavity of the stacked cones wherein the separation resulting from the swirling in the axial cavity from cone to cone till the last stacked cone, the separation from the swirling swirls attaching to the cone shroud in the space between the stacked cones which are in great number, the separation from the swirling that swirls attaching to the shroud of the collecting channel for fluid with bigger or higher density particles, the separation from the reverse swirling. Therefore, the fluid can be sorted to meet the requirement without additional filter. The separator is thus not prone to be clogged and does not require frequent maintenance. It is thus suitable to be applied as a household vacuum cleaner, especially, a portable vacuum cleaner or a handheld vacuum cleaner.

FIG. 1A and FIG. 2 shows a vacuum cleaner using the fluid separator according to the present invention comprising two major parts, i.e., preliminary separating section (2, 102) used in separating big and elongated or fibrous impurities and fluid separating section which is the fluid separator according to the present invention (1, 101) mentioned above. The preliminary separating section includes an inlet (3, 103) for the impurities drawn in with air, a vortex generating device (4, 104), a vortex generating chamber (5, 105), a vortex generating chamber shroud (6, 106), a big and fibrous impurity storage chamber (8, 108), a big and fibrous impurity storage chamber shroud (7, 107), a concave side shroud (9, 19) of the storage chamber for big and fibrous impurity adjacent to the inlet tube for the impurities drawn in with air, connection passage (10, 110) axially connected with the fluid separator according to the present invention (1, 101), an vacuum cleaner handle (33, 133) mounted axially extending from the outlet of the completely sorted air, which is the telescopic handle wherein stretchable/retractable to suit the working requirement.

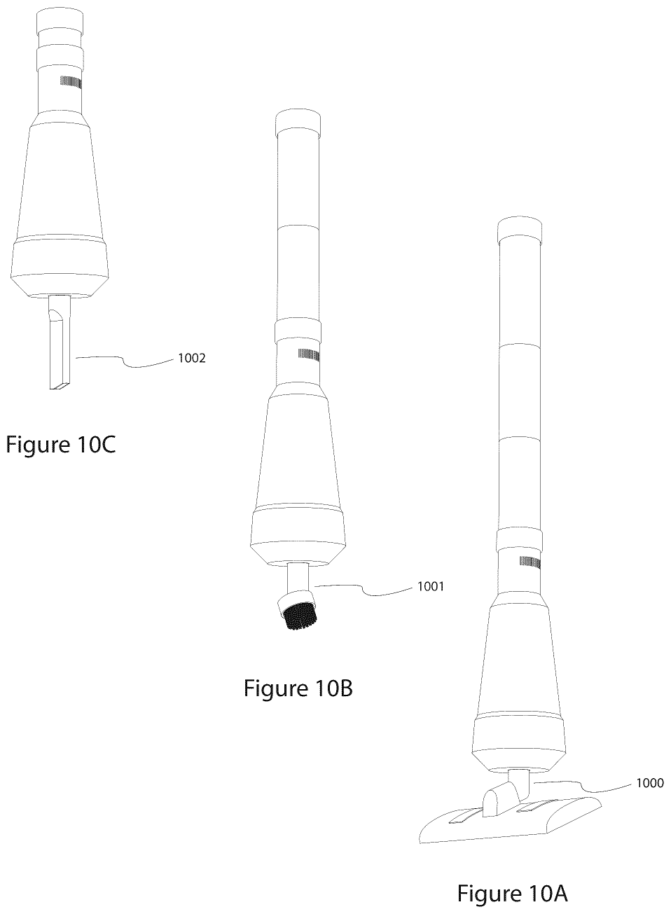

The inlet for impurities drawn in with air can be connectable with the floor vacuum head (1000) according to FIG. 10A or connected with the round brush vacuum head (1001) according to FIG. 10B or connected with the cutting edge vacuum head (1002) according to FIG. 10C.

The vortex generating device used in the preliminary separating section for the large impurities can be either the conical or shallow circular dome vortex generating device.

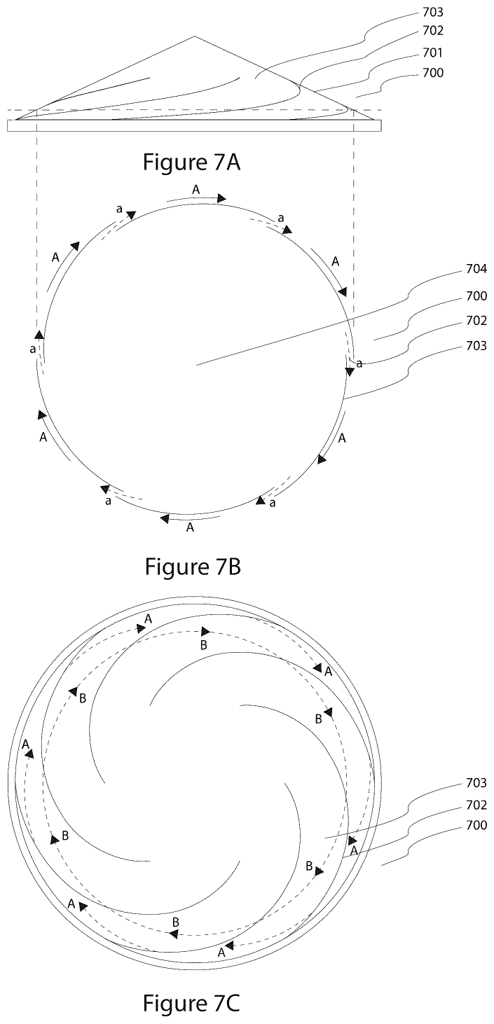

According to FIGS. 7A, 7B and 7C show the conical vortex generating device (700) which is the conical transmission base (701). Inside the hollow cone is the internal cavity (704) for fluid distribution, connected with impurity inlet drawn in impurity along with air carrying the fluid through the cone base. In case the conical transmission base is larger than the fluid inlet tube, the portion under the cone base which is larger than the fluid inlet tube will be covered by the lower shroud to be connected with the fluid inlet to direct the flow of fluid towards the conical transmission base. At the cone shroud provided with aperture (702) concentric bending and penetrating from inside through the cone to the outside cone shroud. The aperture is in long channel mounted above the cone base edge for a certain extent. The aperture space may be of equal width for the entire aperture. A plurality of apertures and convex curve surfaces beside the apertures are disposed symmetrically around the cone. The emerging axis of the aperture (a) is adjacent to the convex curve surface (703) beside the aperture which is the surface curving along the shape of the outside cone shroud. The convex curve surface (703) beside the aperture is the surface closest to the emerging axis (a) of the aperture compared to the surfaces around the emerging axis (a) of the aperture. The aperture (702) concentric bending, the tail section of the aperture curves or bends more concentric than the head section. The plurality of apertures and convex curve surfaces beside the aperture are disposed symmetrically around the cone, with the placement of the aperture the emerging axis of the aperture, the convex curve surface (703) beside the aperture mentioned above, with Coanda Effect, when the fluid is drawn or driven through the aperture, the fluid will be deflected to flow attaching to the convex curve surface (703) beside the aperture, flows attaching along the convex curve surface (703) of the external cone shroud even though the convex curve surface of the cone deviated beyond the emerging axis (a) of the aperture, and induces the fluid in the vortex generating chamber to flow into and flows attaching along the convex curve surface (703) beside the aperture along the flow path A. With the placement of the aperture symmetrically around the cone, the fluid flows in relays around the cone, thereby generating the swirling flow around the cone along the flow path B. With Coanda effect that the fluid flows attaching to the surface, the generated vortex is laminar swirling flow and therefore will not cause turbulent flow. With the conical fluid distributing chamber, the space between apertures close to the cone base rim will become narrower and the aperture of which tail section bends more concentric, the swirling at the outer layer thus has higher swirling velocity than the swirling at the inner layer, which is the forced vortex type vortex. Since the centrifugal force varies directly with the swirling velocity, centrifugal force at the outer layer is thus higher than that at the inner layer.

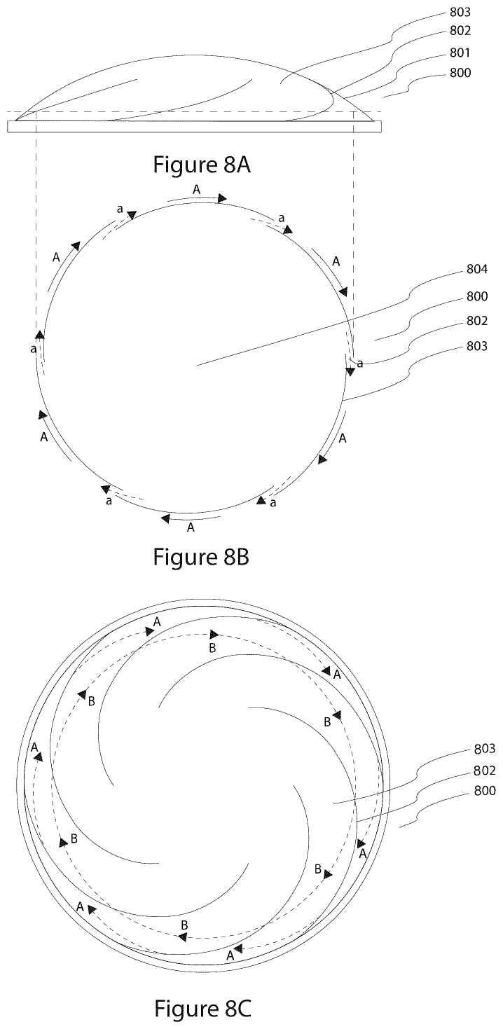

FIGS. 8A, 8B and 8C show the vortex generating device with a shallow circular dome (800). The shallow dome is the transmission base (801). Inside the hollow dome is the interna cavity (804) used as the fluid distributing chamber connected with the impurity inlet. The impurities are drawn in along with air carrying the fluid through the cone base. In case the shallow circular dome is larger than the fluid inlet, the portion under the dome base which is larger than the fluid inlet will be provided with the cover shroud to direct the flow of the fluid towards the shallow circular dome transmission base. At the dome shroud, the concentric bending aperture (802) penetrating from inside of the dome to the external shroud of the dome, wherein the aperture is in shape of a long channel extending from the cone base rim to a certain extent. The long channel aperture does not extend to reach the center of the dome tip. The aperture may have equal width along the entire length. A plurality of apertures are disposed symmetrically around the circular dome, beside the aperture is the convex curve surface that curves along the dome shape. The convex curve surface (803) beside the aperture is disposed as the closest surface to the emerging axis (a) of the aperture compared to the other surfaces around the emerging axis (a) of the aperture. The aperture (802) bends concentrically. The tail section of the aperture bends more concentric than the head section of the aperture and the convex curve surfaces beside the plurality of the apertures are disposed symmetrically around the shroud of shallow dome. When the fluid is drawn or driven through the aperture (802), with Coanda effect, the fluid flow will be deflected to flow attaching to the convex curve surface (803) beside the aperture along the flow path A. With the plurality of apertures and convex curve surfaces beside the apertures disposed symmetrically around the outer shroud of the dome, the flow flows in relays to generate swirling flow around the dome along the flow path B. With the tail section of the aperture bending more concentric than the head section of the aperture as well as the space between apertures becomes narrowest at the dome rim, the swirling velocity reaches its highest value at the shallow dome shaped base rim. The swirling velocity decreases towards the center of the circular dome. The generated vortex is thus the forced vortex. With Coanda effect, the fluid flow attaching to the convex curve surface (803) beside the aperture, the vortex is, therefore, a laminar swirling flow. This prevents the turbulent flow. Since the centrifugal force varies directly with the vortex velocity, the centrifugal force at the outer layer is thus higher than the centrifugal force at the inner layer.

FIG. 1A and FIG. 2 show the vortex generating chamber (5, 105) of the preliminary separating section is the cavity outside the vortex generating device which derived from cone covering the vortex generating device (4, 104) leaving a space between the covering cone and the vortex generating device. The covering cone shroud (6, 106) of the vortex generating chamber extends lower than the base level of the vortex generating device and the other side of the shroud (9, 109) of the vortex generating chamber beside the fluid inlet forms a concave curve. When impurities along with air are drawn through the vortex generating device (4, 104). Large impurities acted upon by the highest centrifugal force are thrown to swirl attaching to the vortex generating chamber shroud (6, 106) and then flows downward to the large impurity storage chamber (8, 108). With the narrowing lower portion shroud (7, 107) of the storage chamber for large impurity and the shroud at the other side (9, 109) adjacent to the fluid inlet being concave, by the inertia force of the vortex, the impurities will swirl in loop inside the large impurity storage chamber (8, 108). The large impurity storage chamber is removable from the vacuum cleaner for the disposal of the impurities, while the small impurities such as dust that swirls at the inner layer of the vortex will be drawn into the fluid separator according to the present invention (1, 101) via the fluid inlet (10, 110), and then into the separation system of the fluid separator according to the present invention (1, 101) mentioned above.

The aforementioned vacuum cleaner not only used as a household vacuum cleaner, it is also applicable for air filtering in the air conditioner, the air filter for the internal combustion engine, or applicable with the dust filtering or fluid separation in the industry. To improve separating efficiency, an additional vacuum fan can be provided coaxially with the main vacuum fan mounted between the fluid inlet and the vortex generating device of the fluid separator, the additional vacuum fan mounted at the fluid inlet of the preliminary separating section and the vortex generating device to increase the force of drawing in and driving out so that the device will be fully functional. In case the additional vacuum fan is mounted at the fluid inlet of the preliminary separating section, the vortex generating device can also be the vortex generating device with fluid guide vanes, or the vortex generating device with stationary blades to generate the vortex.

### BEST MODE OF THE INVENTION

The best mode of the invention is the same as disclosed in the Detailed Description of Invention.

1. A cone stack cyclone separator with stacked cones comprising
a fluid inlet,
a vortex generating device,
a vacuum motor fan mounted between the fluid inlet and the vortex generating device,
a vortex generating chamber connected after the vortex generating device,
a separating section axially connected after the vortex generating chamber including an internal cavity formed by a downstream open end of the stacked cones; and at least one space between the stacked cones,
a collecting channel for fluid with bigger or higher density particles mounted at the upstream open end of the stacked cones,
a reverse swirl facilitating cone mounted at the lower end of the collecting channel for fluid with bigger or higher density particles,
an annular space for the fluid separation between a shroud of the collecting channel for fluid with bigger or higher density particles and the reverse swirl facilitating cone,
a storage chamber for fluid with bigger or higher density particles mounted after the annular space for the fluid separation,
a fluid connecting channel connected between the collecting channel for fluid with bigger or higher density particles and the fluid inlet, wherein
an inlet entrance of the connecting channel is disposed at the end of the reverse swirl facilitating cone,
an outlet of the connecting channel is disposed beside the fluid inlet, and
an outlet for fluid with smaller or lower density particles is mounted after the downstream open end of the last of the stacked cones.

2. A cone stack cyclone separator comprising
a fluid inlet,
a vortex generating device,
a vacuum motor fan mounted between the fluid inlet and the vortex generating device,
a vortex generating chamber mounted after the vortex generating device, and
a Coanda screen cone is axially connected after the vortex generating chamber, wherein
the Coanda screen cone is a truncated cone-shape structure having both upstream and downstream open ends and a shroud wrapped by wedge wires,
the wedge wires have a triangle cross section,
the wedge wires are longitudinally fixed to the cone-shape structure with narrow spaces between the wedge wires, wherein a flat side of the triangle cross section faces inward to be the inner cone shroud of the Coanda screen cone while an end of the triangle cross section faces outward of the cone-shape structure, with curvature of circumference of the Coanda screen cone the flat side of a subsequent wedge wire (based on the flow direction) has an uprisen angle from the flat side of a preceding wedge wire in the flow direction,
the cone stack separator further comprises
a collecting channel for fluid with bigger or higher density particles including a space between a covering cone and the Coanda screen cone,
a reverse swirl facilitating cone mounted at a lower end of the collecting channel for fluid with bigger or higher density particles,
an annular space for fluid separation between a shroud of the collecting channel for fluid with bigger or higher density particles and the reverse swirl facilitating cone,
a storage chamber for fluid with bigger or higher density particles mounted after the annular space for fluid separation, and
a fluid connecting channel connected between the collecting channel for fluid with bigger or higher density particles and the fluid inlet, wherein
an inlet entrance of the connecting channel is located at an end of the reverse swirl facilitating cone, and
an outlet of the connecting channel is located beside the fluid inlet, and
an outlet of the fluid with smaller or lower density particles is mounted after the downstream open end of the Coanda screen cone.

3. A vacuum cleaner comprising
the cone stack cyclone separator according to claim 1, and
a preliminary separating section used in separating large impurities comprising
an inlet for impurities drawn in along with air,
a vortex generating device,
a vortex generating chamber,
a large impurity storage chamber, wherein
the vortex generating chamber of the preliminary separating section is connected to the fluid inlet of the cone stack cyclone separator.

4. A vacuum cleaner comprising
the cone stack cyclone separator according to claim 2, and
a preliminary separating section used in separating large impurities comprising
an inlet for impurities drawn in along with air,
a vortex generating device,
a vortex generating chamber,
a large impurity storage chamber, wherein
the vortex generating chamber of the preliminary separating section is connected to the fluid inlet of the cone stack cyclone separator.

5. A vortex generating device comprising
stationary blades with aerodynamic surface mounted in an annular space between a hub and an outer shroud of a cylindrical or conical tube, wherein:
a space of the hub is closed to allow a fluid to pass through only the annular space,
a leading edge of each stationary blade convexly curves for a certain extent,
a spine side of each stationary blade convexly curves along the entire length to a trailing edge of the stationary blade,
a concave curve side of each stationary blade has a certain thickness,
an outer edge of each stationary blade bends in a bigger angle and extends longer than an inner edge of each stationary blade,
each stationary blade slightly curves down at the trailing edge,
a curving-down end at the outer edge of each stationary blade curves down to lower elevation than that of the curving-down end at the inner edge,
a space between the trailing edges of the stationary blades is narrower than a space between the leading edges of the stationary blades,
a wide side of each stationary blade is mounted transversely with respect to the annular space between the hub and the shroud of the cylindrical tube or the conical tube,
the long side of the stationary blade is mounted from upstream of the annular space between the hub and the shroud of the cylindrical or conical tube and is bent concentrically,
axially to the downstream of the cylindrical or conical tube, stationary blades are mounted with respect to a direction and degree of the blowing of a vacuum motor fan to drive the fluid to collide with the convex spine side of the leading edge of the stationary blades, and
a plurality of stationary blades are mounted symmetrically around the hub in the annular space between the hub and the shroud of the cylindrical or conical tube.

6. A vortex generating device comprising
guide vanes mounted in an annular space between a hub and a shroud of a cylindrical or conical tube, wherein
a wide side of each guide vane is mounted transversely,
a long side of each guide vane is mounted longitudinally bending concentrically around the hub from upstream to downstream in the annular space between the hub and the shroud of the cylindrical or conical tube while a spine side of the guide vanes convexly curves from a leading tip to end parts of the guide vanes,
the end part of each guide vane bends transversely concentrically and slightly curves down,
an outer edge of each guide vane bends in bigger degree and extends longer than an inner edge of the guide vane,
a curving-down end at the outer edge of the guide vane curves down to lower elevation than a curving-down end at the inner edge of each guide vane,
a space between trailing edges of the guide vanes is narrower than a space between leading edges of the guide vanes,
the guide vanes are mounted with respect to the direction and the blowing degrees of a vacuum motor fan to drive a fluid to collide with the spine side of the leading edge of the guide vanes which is the convex curve surface of the guide vanes, and
a plurality of the guide vanes are mounted symmetrically around the hub in the annular space between the hub and the shroud of the cylindrical or conical tube.

7. A vortex generating device comprising
a transmission base having a conical or cylindrical shape with a hollow internal cavity,
a fluid inlet,
a fluid distributing chamber,
an aperture penetrating from outside of the vortex generating device to the internal cavity of the transmission base,
a convex curve surface beside the aperture curving towards an inner shroud of the transmission base,
a convex curve surface beside the aperture which is the closest surface to an emerging axis of the aperture compared to other surfaces around the emerging axis, and
a plurality of the apertures and convex curve surfaces beside the apertures are mounted symmetrically around the transmission base.

8. A vortex generating device comprising
a conical transmission base with a hollow conical internal cavity,
a fluid inlet connected underneath the base of the conical transmission base, wherein
the conical internal cavity is a fluid distributing chamber,
an aperture is mounted at a shroud of the conical transmission base and penetrates from inside the conical transmission base to outside of the conical transmission base with an emerging axis,
the aperture is a long channel extending from a base rim up to a certain extent, and bends concentrically, wherein a tail section of the aperture bends more concentric than a head section of the aperture at a side close to a tip of the conical transmission base,
beside the aperture is a convex curve surface which is a portion of the shroud surface of the conical transmission base,
the convex curve surface beside the aperture is the surface closest to the emerging axis of the aperture compared to the other surfaces around the emerging axis of the aperture, and
a plurality of the apertures and the convex curve surfaces beside the apertures are disposed symmetrically around the shroud of the conical transmission base.

9. A vortex generating device comprising
a shallow dome transmission base with a hollow internal cavity,
a fluid inlet connected with the base of the shallow dome transmission base, wherein
the internal cavity of the shallow dome is a fluid distributing chamber,
an aperture mounted at a shroud of the shallow dome transmission base penetrating from inside of the shallow dome transmission base to the outside of the shallow dome transmission base with an emerging axis adjacent to the external shroud of shallow dome transmission base,
the aperture is a long channel extends from a base rim up to a certain extent,
the aperture bends concentrically wherein a tail section of the aperture close to the base bends more concentric than a head section of the aperture close to a dome tip,
beside the aperture is the convex curve surface which is a portion of the shroud surface of the shallow dome transmission base,
the convex curve surface beside the aperture is the surface closest to the emerging axis of the aperture compared to the other surfaces around the emerging axis of the aperture, and
a plurality of the apertures and the convex curve surfaces beside the aperture are disposed symmetrically around the shallow dome transmission base.

10. The cone stack cyclone separator according to claim 1 further comprising
a vortex generating device comprising stationary blades with aerodynamic surface mounted in an annular space between a hub and an outer shroud of a cylindrical or conical tube, wherein
a space of the hub is closed to allow a fluid to pass through only the annular space,
a leading edge of each stationary blade convexly curves for a certain extent,
a spine side of each stationary blade convexly curves along the entire length to a trailing edge of the stationary blade,
a concave curve side of each stationary blade has a certain thickness,
an outer edge of each stationary blade bends in a bigger angle and extends longer than an inner edge of each stationary blade,
each stationary blade slightly curves down at the trailing edge,
a curving-down end at the outer edge of each stationary blade curves down to lower elevation than that of the curving-down end at the inner edge,
a space between the trailing edges of the stationary blades is narrower than a space between the leading edges of the stationary blades,
a wide side of each stationary blade is mounted transversely with respect to the annular space between the hub and the shroud of the cylindrical tube or the conical tube,
the long side of the stationary blade is mounted from upstream of the annular space between the hub and the shroud of the cylindrical or conical tube and is bent concentrically,
axially to the downstream of the cylindrical or conical tube, stationary blades are mounted with respect to a direction and degree of the blowing of a vacuum motor fan to drive the fluid to collide with the convex spine side of the leading edge of the stationary blades, and
a plurality of stationary blades are mounted symmetrically around the hub in the annular space between the hub and the shroud of the cylindrical or conical tube.

11. A cone stack cyclone separator having stacked cones according to claim 1 further comprising
a vortex generating device comprising guide vanes mounted in the annular space between the hub and the shroud of the cylindrical or conical tube, wherein:
the wide side of the guide vane is mounted transversely,
the long side of the guide vane mounted longitudinally bending concentrically around the hub from upstream to downstream in the annular space between the hub and the shroud of the cylindrical or conical tube while the spine side of the guide vanes convexly curves from the leading tip to the ends of the guide vanes,
wherein the end part of the guide vanes bends transversely concentrically and slightly curves down,
the outer edge of the guide vane bends in bigger degree and extends longer than the inner edge of the guide vane, curving-down end at the outer edge of the guide vane curves down to lower elevation than curving-down end at the inner edge of the guide vane,
the space between trailing edges of the guide vane should be narrower than the space between leading edges of the guide vane,
the guide vane is mounted with respect to the direction and the blowing degrees of the vacuum motor fan to drive the fluid to collide with the spine side of the leading edge of the guide vane which is the convex curve surface of the guide vane, and
a plurality of the guide vanes are mounted symmetrically around the hub in the annular space between the hub and the shroud of the cylindrical or conical tube.

12. The cone stack cyclone separator having stacked cones according to claim 1 further comprising a vortex generating device comprising
a transmission base having a conical or cylindrical shape of which inside is the hollow internal cavity in accordance with the conical or cylindrical shape of the transmission base,
a fluid inlet, a fluid distributing chamber, an aperture penetrating from the outside to the internal cavity of the transmission base,
convex curve surface beside the aperture curving towards the inner shroud of the transmission base, convex curve surface beside the aperture which is the closest surface to the emerging axis of the aperture compared to other surfaces around the emerging axis, and
a plurality of the apertures and convex curve surfaces beside the apertures are mounted symmetrically around the transmission base.

13. The cone stack cyclone separator according to claim 2 further comprising a vortex generating device comprising stationary blades with aerodynamic surface mounted in the annular space between a hub and an outer shroud of the cylindrical or conical tube, wherein
the space of the hub was closed to allow the fluid to pass through only the annular space,
the leading edge of the stationary blade convexly curves for a certain extent, the spine side of the stationary blade convexly curves along the entire length to the trailing edge of the stationary blade,
the concave curve side of the stationary blade has a certain thickness, the outer edge of the stationary blade bends in bigger angle and extends longer than the inner edge of the stationary blade,
the stationary blades slightly curves down at the trailing edge of the stationary blade,
the curving-down end at the outer edge of the stationary blade curves down to the lower elevation than that of the curving-down end at the inner edge of the stationary blade,
the space between trailing edges of the stationary blades should be narrower than the space between the leading edges of the stationary blades,
the wide side of the stationary blade is mounted transversely with respect to the annular space between the hub and the shroud of the cylindrical tube or the conical tube,
the long side of the stationary blade is mounted from upstream of the annular space between the hub and the shroud of the cylindrical or conical tube bent concentrically,
axially to the downstream of the cylindrical or conical tube, stationary blades are mounted with respect to the direction and degree of the blowing of the vacuum motor fan to drive the fluid to collide with the convex spine side of the leading edge of the stationary blade, and
a plurality of stationary blades are mounted symmetrically around the hub in the annular space between the hub and the shroud of the cylindrical or conical tube.

14. The cone stack cyclone separator according to claim 2 further comprising a vortex generating device comprising guide vanes mounted in the annular space between the hub and the shroud of the cylindrical or conical tube, wherein
the wide side of the guide vane is mounted transversely,
the long side of the guide vane mounted longitudinally bending concentrically around the hub from upstream to downstream in the annular space between the hub and the shroud of the cylindrical or conical tube while the spine side of the guide vanes convexly curves from the leading tip to the ends of the guide vanes,
wherein the end part of the guide vanes bends transversely concentrically and slightly curves down,
the outer edge of the guide vane bends in bigger degree and extends longer than the inner edge of the guide vane, curving-down end at the outer edge of the guide vane curves down to lower elevation than curving-down end at the inner edge of the guide vane,
the space between trailing edges of the guide vane should be narrower than the space between leading edges of the guide vane,
the guide vane is mounted with respect to the direction and the blowing degrees of the vacuum motor fan to drive the fluid to collide with the spine side of the leading edge of the guide vane which is the convex curve surface of the guide vane, and
a plurality of the guide vanes are mounted symmetrically around the hub in the annular space between the hub and the shroud of the cylindrical or conical tube.

15. The cone stack cyclone separator according to claim 2 further comprising a vortex generating device comprising
a transmission base having a conical or cylindrical shape of which inside is the hollow internal cavity in accordance with the conical or cylindrical shape of the transmission base,
a fluid inlet, a fluid distributing chamber, an aperture penetrating from the outside to the internal cavity of the transmission base,
convex curve surface beside the aperture curving towards the inner shroud of the transmission base, convex curve surface beside the aperture which is the closest surface to the emerging axis of the aperture compared to other surfaces around the emerging axis, and
a plurality of the apertures and convex curve surfaces beside the apertures are mounted symmetrically around the transmission base.

16. The vacuum cleaner according to claim 3 comprising cone stack cyclone separator comprising stationary blades with aerodynamic surface mounted in the annular space between a hub and an outer shroud of the cylindrical or conical tube, wherein:
the space of the hub was closed to allow the fluid to pass through only the annular space,
the leading edge of the stationary blade convexly curves for a certain extent, the spine side of the stationary blade convexly curves along the entire length to the trailing edge of the stationary blade,
the concave curve side of the stationary blade has a certain thickness, the outer edge of the stationary blade bends in bigger angle and extends longer than the inner edge of the stationary blade,
the stationary blades slightly curves down at the trailing edge of the stationary blade,
the curving-down end at the outer edge of the stationary blade curves down to the lower elevation than that of the curving-down end at the inner edge of the stationary blade,
the space between trailing edges of the stationary blades should be narrower than the space between the leading edges of the stationary blades,
the wide side of the stationary blade is mounted transversely with respect to the annular space between the hub and the shroud of the cylindrical tube or the conical tube,
the long side of the stationary blade is mounted from upstream of the annular space between the hub and the shroud of the cylindrical or conical tube bent concentrically,
axially to the downstream of the cylindrical or conical tube, stationary blades are mounted with respect to the direction and degree of the blowing of the vacuum motor fan to drive the fluid to collide with the convex spine side of the leading edge of the stationary blade, and
a plurality of stationary blades are mounted symmetrically around the hub in the annular space between the hub and the shroud of the cylindrical or conical tube.

17. The vacuum cleaner according to claim 3 comprising cone stack cyclone separator comprising guide vanes mounted in the annular space between the hub and the shroud of the cylindrical or conical tube, wherein:
the wide side of the guide vane is mounted transversely,
the long side of the guide vane mounted longitudinally bending concentrically around the hub from upstream to downstream in the annular space between the hub and the shroud of the cylindrical or conical tube while the spine side of the guide vanes convexly curves from the leading tip to the ends of the guide vanes,
wherein the end part of the guide vanes bends transversely concentrically and slightly curves down,
the outer edge of the guide vane bends in bigger degree and extends longer than the inner edge of the guide vane, curving-down end at the outer edge of the guide vane curves down to lower elevation than curving-down end at the inner edge of the guide vane,
the space between trailing edges of the guide vane should be narrower than the space between leading edges of the guide vane,
the guide vane is mounted with respect to the direction and the blowing degrees of the vacuum motor fan to drive the fluid to collide with the spine side of the leading edge of the guide vane which is the convex curve surface of the guide vane, and
a plurality of the guide vanes are mounted symmetrically around the hub in the annular space between the hub and the shroud of the cylindrical or conical tube.

18. The vacuum cleaner according to claim 3 comprising cone stack cyclone separator with vortex generating device which generate vortex with Coanda effect principle comprising
a transmission base having a conical or cylindrical shape of which inside is the hollow internal cavity in accordance with the conical or cylindrical shape of the transmission base,
a fluid inlet, a fluid distributing chamber, an aperture penetrating from the outside to the internal cavity of the transmission base,
convex curve surface beside the aperture curving towards the inner shroud of the transmission base, convex curve surface beside the aperture which is the closest surface to the emerging axis of the aperture compared to other surfaces around the emerging axis, and
a plurality of the apertures and convex curve surfaces beside the apertures are mounted symmetrically around the transmission base.

19. The vacuum cleaner according to claim 4 comprising cone stack cyclone separator comprising stationary blades with aerodynamic surface mounted in the annular space between a hub and an outer shroud of the cylindrical or conical tube, wherein:
the space of the hub was closed to allow the fluid to pass through only the annular space,
the leading edge of the stationary blade convexly curves for a certain extent, the spine side of the stationary blade convexly curves along the entire length to the trailing edge of the stationary blade,
the concave curve side of the stationary blade has a certain thickness, the outer edge of the stationary blade bends in bigger angle and extends longer than the inner edge of the stationary blade,
the stationary blades slightly curves down at the trailing edge of the stationary blade,
the curving-down end at the outer edge of the stationary blade curves down to the lower elevation than that of the curving-down end at the inner edge of the stationary blade,
the space between trailing edges of the stationary blades should be narrower than the space between the leading edges of the stationary blades,
the wide side of the stationary blade is mounted transversely with respect to the annular space between the hub and the shroud of the cylindrical tube or the conical tube,
the long side of the stationary blade is mounted from upstream of the annular space between the hub and the shroud of the cylindrical or conical tube bent concentrically,
axially to the downstream of the cylindrical or conical tube, stationary blades are mounted with respect to the direction and degree of the blowing of the vacuum motor fan to drive the fluid to collide with the convex spine side of the leading edge of the stationary blade, and
a plurality of stationary blades are mounted symmetrically around the hub in the annular space between the hub and the shroud of the cylindrical or conical tube.

20. The vacuum cleaner according to claim 4 comprising cone stack cyclone separator comprising guide vanes mounted in the annular space between the hub and the shroud of the cylindrical or conical tube, wherein:
the wide side of the guide vane is mounted transversely,
the long side of the guide vane mounted longitudinally bending concentrically around the hub from upstream to downstream in the annular space between the hub and the shroud of the cylindrical or conical tube while the spine side of the guide vanes convexly curves from the leading tip to the ends of the guide vanes,
wherein the end part of the guide vanes bends transversely concentrically and slightly curves down,
the outer edge of the guide vane bends in bigger degree and extends longer than the inner edge of the guide vane, curving-down end at the outer edge of the guide vane curves down to lower elevation than curving-down end at the inner edge of the guide vane,
the space between trailing edges of the guide vane should be narrower than the space between leading edges of the guide vane,
the guide vane is mounted with respect to the direction and the blowing degrees of the vacuum motor fan to drive the fluid to collide with the spine side of the leading edge of the guide vane which is the convex curve surface of the guide vane, and
a plurality of the guide vanes are mounted symmetrically around the hub in the annular space between the hub and the shroud of the cylindrical or conical tube.

21. The vacuum cleaner according to claim 4 comprising cone stack cyclone separator with vortex generating device which generate vortex with Coanda effect principle comprising
a transmission base having a conical or cylindrical shape of which inside is the hollow internal cavity in accordance with the conical or cylindrical shape of the transmission base,
a fluid inlet, a fluid distributing chamber, an aperture penetrating from the outside to the internal cavity of the transmission base,
convex curve surface beside the aperture curving towards the inner shroud of the transmission base, convex curve surface beside the aperture which is the closest surface to the emerging axis of the aperture compared to other surfaces around the emerging axis, and
a plurality of the apertures and convex curve surfaces beside the apertures are mounted symmetrically around the transmission base.

22. The vacuum cleaner according to claim 3, wherein the preliminary separating section comprising the vortex generating device with a conical shape generating vortex around the external surface of the cone comprising
a conical transmission base of which inside is the hollow conical internal cavity of the transmission base,
a fluid inlet connected underneath the cone base of the transmission base,
wherein:
the cone internal cavity is the fluid distributing chamber,
the aperture mounted at the cone shroud penetrating from inside the cone to outside of the cone with the emerging axis of the aperture spouts adjacent to the external shroud of the cone,
the aperture is a long channel extending from the base rim up to a certain extent, the aperture bends concentrically, wherein the tail section of the aperture bends more concentric than the head section of the aperture at the side close to the tip of the cone,
beside the aperture is the convex curve surface beside the aperture which is a portion of the shroud surface of the conical transmission base,
the convex curve surface beside the aperture is the surface closest to the emerging axis of the aperture compared to the other surfaces around the emerging axis of the aperture, and
the plurality of apertures and the convex curve surfaces beside the apertures are disposed symmetrically around the shroud of the conical transmission base.

23. The vacuum cleaner according to claim 3, wherein the preliminary separating section comprising the vortex generating device with shallow dome generating vortex around the dome comprising a shallow dome transmission base, wherein:
inside of the shallow dome is hollow corresponding to the shallow dome shape is the internal cavity of the transmission base,
the fluid inlet connected with the base of the shallow dome which is the transmission base,
the internal cavity of the shallow dome is the fluid distributing chamber,
aperture mounted at the dome shroud penetrating from inside of the dome to the outside of the shallow dome with the emerging axis of the aperture is adjacent to the external shroud of shallow dome,
the aperture is a long channel extends from the base rim up to a certain extent,
the aperture bends concentrically wherein the tail section of the aperture close to the dome base bends more concentric than the head section of the aperture close to the dome tip,
beside the aperture is the convex curve surface beside the aperture which is a portion of the shroud surface of the shallow dome transmission base,
the convex curve surface beside the aperture is the surface closest to the emerging axis of the aperture compared to the other surfaces around the emerging axis of the aperture, and
the plurality of apertures and the convex curve surfaces beside the aperture are disposed symmetrically around the shallow dome transmission base.

24. The cone stack cyclone separator according to claim 1, wherein, beside the shroud at the bottom of the storage chamber an opening-closing valve is mounted to transfer the fluid with bigger or higher density particles out of the storage chamber.

25. The cone stack cyclone separator according to claim 2 further includes
a short cut flow prevention cone for preventing the short cut flow from the fluid that swirls in the collecting channel for fluid with bigger or higher density particles to swirl directly to the connecting channel located at the reverse swirl facilitating cone end connected between the collecting channel for fluid with bigger particles with the fluid inlet of the fluid separator before flowing to the annular space used in separation,
wherein the short cut flow prevention cone opens the space at the cone base so that the fluid in the collecting channel for fluid with bigger or higher density particles will flow to the annular separating space.

26. The cone stack cyclone separator according to claim 1, wherein,
at the outlet located at the end of the separating chamber is mounted with a cylindrical tube with both upstream and downstream open end,
the diameter of the cylindrical tube is smaller than that of the downstream open end of the last stacked cone or the downstream open end of the Coanda screen cone,
the annular space between the cylindrical tube and the last stacked cones or the Coanda screen cone for use as an annular separating space, to separate the fluid that swirls at the outer layer which is the fluid with bigger or higher density particles for the last time before discharging the remaining completely sorted fluid out of the separator through the outlet, and
the end edge of the cylindrical tube is higher than the downstream end of the last stacked cones or downstream end of Coanda screen cone and covered with cone or ceiling to leave a space for the discharge of the sorted fluid to the collecting channel for fluid with bigger or higher density particles back into the separating system again.

27. A collecting channel for fluid with bigger or higher density particles of the cone stack cyclone separator according to claim 1,
the channel is narrower at upstream and gradually becomes wider when approaching longitudinally to downstream (upstream/downstream are described base on the flow direction) enable to distribute suction force from the vacuum motor fan through the connecting channel between collecting channel for fluid with bigger or higher density particles and the fluid inlet, to draw the fluid to swirl through the spaces between the stacked cones at least one space between the stacked cones or through the space between the wedge wires of every spaces between wedge wires of the Coanda screen cone from upstream to downstream thoroughly downward to the collecting channel for fluid with bigger or higher density particles enable to have a perfect separation from the settling at the surface settling area which is the shroud surface of the stacked cones or spaces between wedge wires of Coanda screen cone.

28. The vacuum motor fan mounted between the fluid inlet and vortex generating device of the cone stack cyclone separator according to claim 1, wherein
the fan blades and the fan motor are mounted separately,
wherein the blades are mounted at the same place between the fluid inlet and the vortex generating device by separating the motor out off the flow path of the fluid to prevent the contamination by the fluid to be sorted, or to prevent the motor from being wetted by water in case of the liquid separation, the motor is mounted with the structure transmitting rotating force through the shaft to the blades.

29. The vacuum cleaner according to claim 3, wherein
the vortex generating chamber of the preliminary separating section is in a conical shape enable the big impurities centrifuged by the centrifugal force from the vortex generating device to collide with the shroud of the conical vortex generating chamber extending lower than the base level of the vortex generating device, falling downward to the storage chamber of big impurities,
the storage chamber shroud is narrower at the bottom portion, the storage chamber shroud at the side of the inlet for impurities drawn in along with air, curving concavely towards the base of the vortex generating device, and
with the inertia force of the vortex, big impurities and air swirl to the storage chamber shroud and then swirl attaching to the shroud of the chamber close to the fluid inlet curving concavely towards the base of the vortex generating device and then swirling to collide with the shroud of the conical vortex generating chamber to generate the vortex in the storage chamber and causing the big impurities to swirl in loop inside the storage chamber to be contained in the storage chamber of large impurities.

30. The vacuum cleaner according to claim 3 comprising a telescopic handle wherein stretchable/retractable to suit a working requirement.

31. The vacuum cleaner according to claim 3 connected with a floor vacuum head or a circular brush head or a cutting edge vacuum head for suction impurities along with air through the fluid inlet into the vacuum cleaner.
